(19) United States
(12) Patent Application Publication
(10) Pub. No.: US 2010/0308743 A1
(43) Pub. Date: Dec. 9, 2010

(54) Light Emitting Diode Driving Device

(75) Inventors: Tsorng-Juu Liang, Kaohsiung City (TW); Wei-Ching Tseng, Kaohsiung City (TW); Chao-Lung Kuo, Tainan County (TW); Jiann-fuh Chen, Tainan County (TW)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: National Cheng Kung University

(21) Appl. No.: 12/630,268

(22) Filed: Dec. 3, 2009

(30) Foreign Application Priority Data
Jun. 8, 2009 (TW) 098119024
Jul. 31, 2009 (TW) 098125874

(51) Int. Cl. H05B 41/16

(52) U.S. Cl. 315/253; 315/246

(57) ABSTRACT

An LED driving device includes: an LED unit outputting a driving current corresponding to an external AC input voltage; and a current limiting unit receiving the driving current from the LED unit, including a parallel connection of a bypass switch and a current limiting circuit, and operable so as to permit flow of the driving current through one of the bypass switch and the current limiting circuit such that the current limiting unit has a first conduction impedance when the bypass switch is in an ON-state, and a second conduction impedance larger than the first conduction impedance when the bypass switch is in an OFF-state.

### CROSS-REFERENCE TO RELATED APPLICATION

This application claims priority of Taiwanese Application Nos. 098119024 and 098125874, filed on Jun. 8, 2009 and Jul. 31, 2009, respectively.

### BACKGROUND OF THE INVENTION

1. Field of the Invention

The invention relates to a driving device, more particularly to a light emitting diode (LED) driving device.

2. Description of the Related Art

AC-LEDs can be directly driven with a commercial AC power source. However, referring to FIGS. 1 and 2, when an AC-LED is designed to have a larger conduction voltage, a conduction angle of the AC-LED will be larger, thereby resulting in lower power factor and higher total harmonic distortion (THD). As a result, the AC-LED endures larger power, thereby increasing difficulty in epitaxy and package. Furthermore, when a current flowing through the AC-LED increases due to an increased input voltage, a droop effect occurs, thereby resulting in a reduced lighting efficiency.

FIG. 3 illustrates a conventional LED driving device disclosed in U.S. Pat. No. 6,989,807. The conventional LED driving device includes a bridge rectifier 30, a current switching circuit 10, a plurality of LEDs, and a voltage detector 20. However, the current switching circuit 10 has a relatively complex structure, thereby increasing difficulty in current control. There are too many components used in the conventional LED driving device, thereby resulting in a relatively large volume and higher costs.

### SUMMARY OF THE INVENTION

Therefore, an object of the present invention is to provide an LED driving device that can overcome the aforesaid drawbacks of the prior art.

According to one aspect of the present invention, an LED driving device comprises:
an LED unit having an input side adapted to receive an external AC input voltage, and an output side, the LED unit outputting at the output side a driving current corresponding to the input voltage; and
a current limiting unit coupled to the output side of the LED unit, and receiving the driving current from the output side of the LED unit, the current limiting unit including a parallel connection of a bypass switch and a current limiting circuit coupled across the output side of the LED unit, the bypass switch being operable between an ON-state and OFF-state.

The current limiting unit is operable so as to permit flow of the driving current through one of the bypass switch and the current limiting circuit such that the current limiting unit has a first conduction impedance when the bypass switch is in the ON-state, and a second conduction impedance larger than the first conduction impedance when the bypass switch is in the OFF-state.

According to another aspect of the present invention, an LED driving device comprises:
an LED unit having an input side adapted to receive an external AC input voltage, and an output side, the LED unit outputting at the output side a driving current corresponding to the input voltage; and
a variable impedance unit coupled across the output side of the LED unit, permitting flow of the driving current therethrough, and having a conduction impedance that is variable based on an adjusting signal.

According to a further aspect of the present invention, an LED driving device comprises:
a bridge rectifier having an input side adapted to receive an external AC input voltage from an AC power source, and an output side;
an LED unit coupled across the output side of the bridge rectifier; and
a current limiting unit adapted to be coupled between the AC power source and the input side of the bridge rectifier, and including two NMOSFETs coupled inversely in parallel, the current limiting unit being operable so as to permit flow of a driving current that is not greater than a predetermined threshold current through the bridge rectifier to the LED unit.

### BRIEF DESCRIPTION OF THE DRAWINGS

Other features and advantages of the present invention will become apparent in the following detailed description of the preferred embodiments with reference to the accompanying drawings, of which:

FIG. 1 is a plot illustrating a relationship among an input voltage, a conduction voltage and total harmonic distortion for an AC-LED;

FIG. 2 is a plot illustrating a relationship among an input voltage, a conduction voltage and power factor for an AC-LED;

FIG. 3 is a schematic electrical circuit diagram of a conventional LED driving circuit;

FIG. 4 is a schematic electrical circuit diagram illustrating the first preferred embodiment of an LED driving device according to the present invention;

FIG. 5 illustrates waveforms of an AC input voltage (vᵢₙ), a driving current (iᵣₑ) outputted by an LED unit of the first preferred embodiment, and a control signal (v_{G}) outputted by a control unit of the first preferred embodiment;

FIG. 6 is a schematic equivalent electrical circuit diagram illustrating the first preferred embodiment when a current limiting unit is operated in one of first and third modes;

FIG. 7 is a schematic equivalent electrical circuit diagram illustrating the first preferred embodiment when the current limiting unit is operated in a second mode;

FIG. 8 is a schematic electrical circuit diagram illustrating the second preferred embodiment of an LED driving device according to the present invention;

FIGS. 9a and 9b illustrate respectively waveforms of the input voltage (vᵢₙ) and an input current (iᵢₙ) supplied to the second preferred embodiment;

FIGS. 9c, 9d and 9e illustrate waveforms of currents (I_{R}, Iₛ₁, Iₛ) flowing through a bypass switch, a switch and a resistor of the second preferred embodiment, respectively;

FIGS. 9f and 9g illustrate waveforms of control signals (v_{G1}, V_{G}) for the bypass switch and the switch, respectively;

FIG. 10 is a schematic equivalent electrical circuit diagram illustrating the second preferred embodiment when a current limiting unit is operated in one of first and third modes;

FIG. 11 is a schematic equivalent electrical circuit diagram illustrating the second preferred embodiment when the current limiting unit is operated in one of second and fourth modes;

FIG. 12 is a schematic equivalent electrical circuit diagram illustrating the second preferred embodiment when the current limiting unit is operated in a third mode;

FIG. 13 is a schematic electrical circuit diagram illustrating the third preferred embodiment of an LED driving device according to the present invention;

FIG. 14 is a schematic electrical circuit diagram illustrating the fourth preferred embodiment of an LED driving device according to the present invention;

FIG. 15 is a schematic electrical circuit diagram illustrating the fifth preferred embodiment of an LED driving device according to the present invention;

FIG. 16 is a schematic electrical circuit diagram illustrating the sixth preferred embodiment of an LED driving device according to the present invention;

FIGS. 17 to 19 are schematic electrical circuit diagrams illustrating first, second and third variations of the sixth preferred embodiment, respectively;

FIG. 20 is a schematic electrical circuit diagram illustrating the seventh preferred embodiment of an LED driving device according to the present invention;

FIG. 21a illustrates waveforms of first, second and third phase voltages (v_{ab}, v_{bc}, v_{ac}) of a three-phase AC input voltage used in the seventh preferred embodiment;

FIG. 21b illustrates a waveform of a voltage (Vᵣₑ) across an output side of an LED unit of the seventh preferred embodiment;

FIGS. 22a and 22b illustrate waveforms of the voltage (Vᵣₑ) and the driving current (iᵣₑ) outputted by the LED unit;

FIG. 22c illustrates a waveform of a control signal (v_{G}) for a bypass switch of the seventh preferred embodiment;

FIG. 23 is a schematic electrical circuit diagram illustrating the eighth preferred embodiment of an LED driving device according to the present invention;

FIGS. 24 and 25 are schematic electrical circuit diagrams illustrating first and second variations of the eighth preferred embodiment, respectively;

FIG. 26 is a schematic electrical circuit diagram illustrating the ninth preferred embodiment of an LED driving device according to the present invention;

FIG. 27 is a schematic electrical circuit diagram illustrating the tenth preferred embodiment of an LED driving device according to the present invention;

FIG. 28 is a schematic electrical circuit diagram illustrating the eleventh preferred embodiment of an LED driving device according to the present invention;

FIG. 29 is a schematic electrical circuit diagram illustrating the twelfth preferred embodiment of an LED driving device according to the present invention;

FIG. 30 illustrates waveforms of an input voltage (vᵢₙ) and an input current (iᵢₙ) in the twelfth preferred embodiment;

FIG. 31 is a schematic electrical circuit diagram illustrating the thirteenth preferred embodiment of an LED driving device according to the present invention;

FIG. 32 is a schematic electrical circuit diagram illustrating the fourteenth preferred embodiment of an LED driving device according to the present invention;

FIG. 33 is a schematic electrical circuit diagram illustrating the fifteenth preferred embodiment of an LED driving device according to the present invention;

FIGS. 34, 35 and 36 are schematic electrical circuit diagrams illustrating respectively first, second and third variations of the fifteenth preferred embodiment;

FIG. 37 is a schematic electrical circuit diagram illustrating the sixteenth preferred embodiment of an LED driving device according to the present invention; and

FIG. 38 illustrates waveforms of an AC input voltage (vᵢₙ) and an input current (iᵢₙ) supplied by an external AC power source of the sixteenth preferred embodiment.

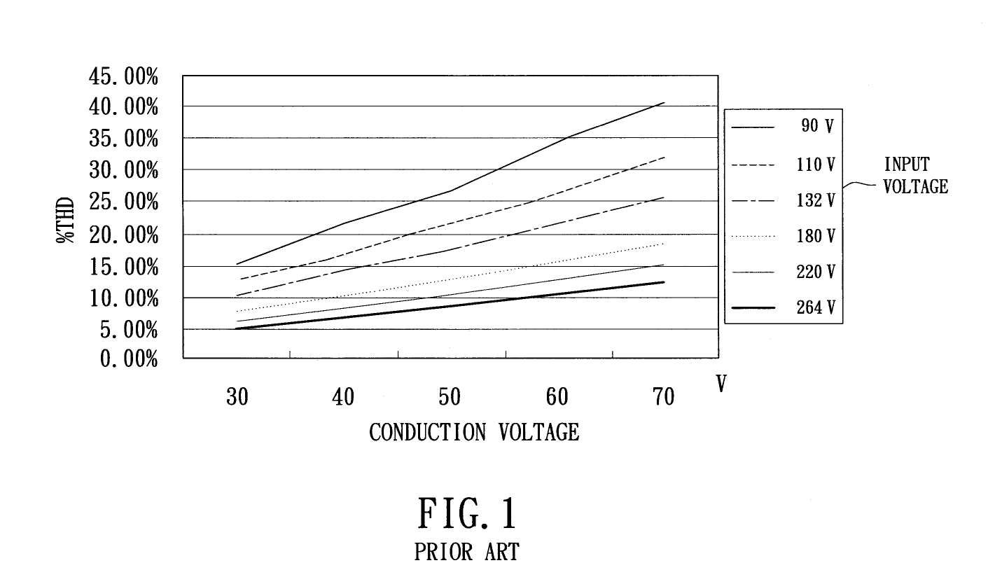

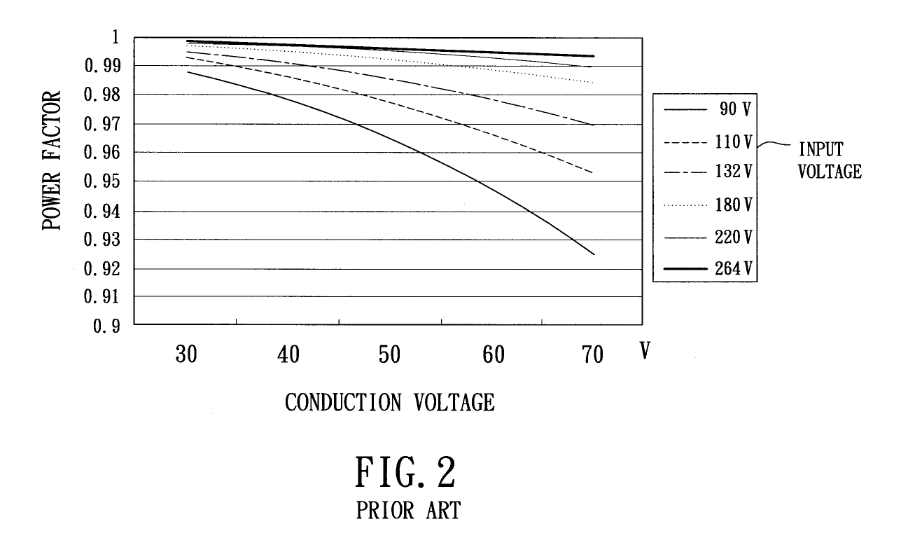

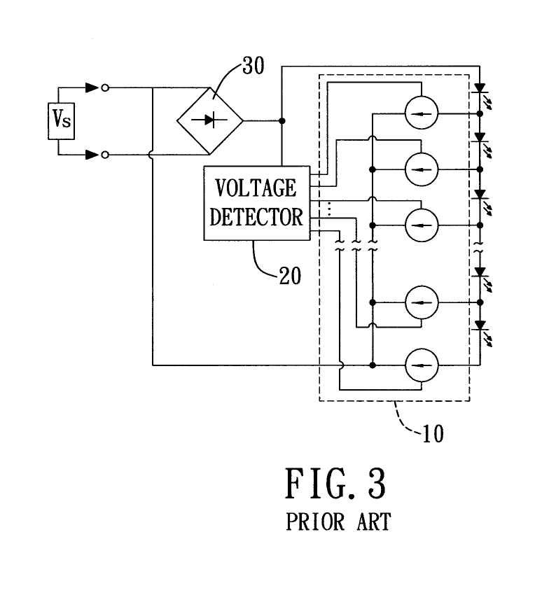

### DETAILED DESCRIPTION OF THE PREFERRED EMBODIMENTS

Before the present invention is described in greater detail, it should be noted that like elements are denoted by the same reference numerals throughout the disclosure.

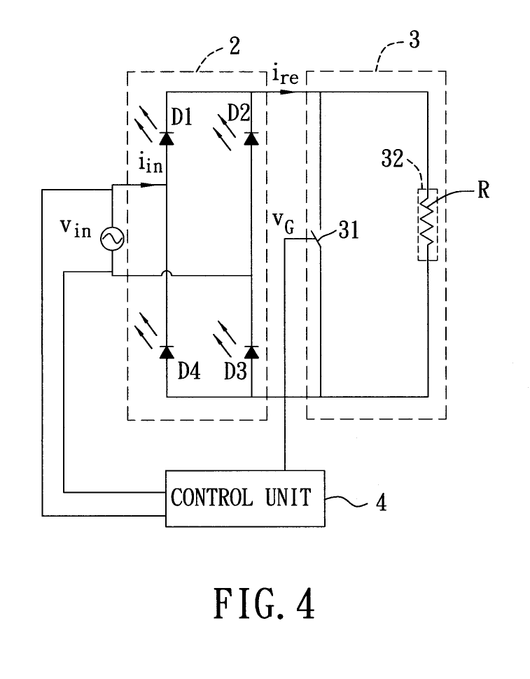

Referring to FIG. 4, the first preferred embodiment of an LED driving device according to the present invention is shown to include an LED unit 2, a current limiting unit 3, and a control unit 4.

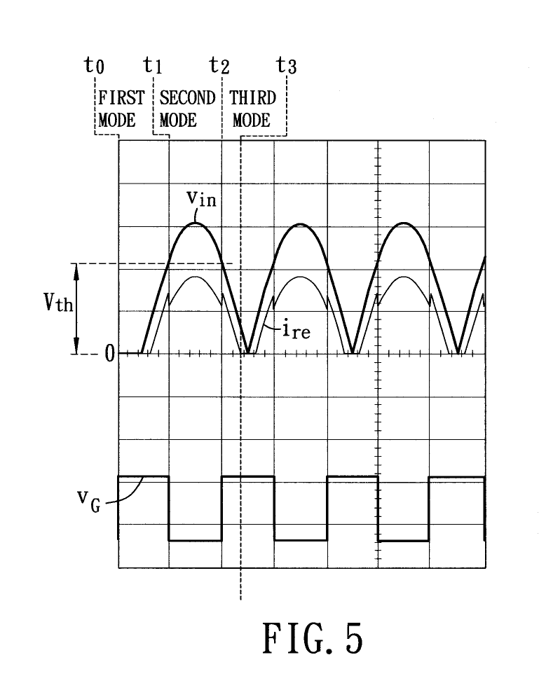

The LED unit 2 has an input side adapted to receive an external AC input voltage (vᵢₙ) from an AC power source (not shown), and an output side. In this embodiment, the input voltage (vᵢₙ) is a sinusoidal signal, as shown in FIG. 5. The LED unit 2 outputs at the output side a driving current (iᵣₑ) corresponding to the input voltage (vᵢₙ). In this embodiment, the LED unit 2 includes four LEDs (D1, D2, D3, D4), such as AC-LEDs, configured as a bridge rectifier adapted for rectifying the input voltage (vᵢₙ) and for outputting at the output side the driving current (iᵣₑ) that corresponds to the input voltage (vᵢₙ) rectified thereby. When the input voltage (vᵢₙ) is a positive half of the sinusoidal signal, the LEDs (D1, D3) conduct. When the input voltage (vᵢₙ) is a negative half of the sinusoidal signal, the LEDs (D2, D4) conduct. The driving current (iᵣₑ) corresponds to an input current (iᵢₙ) supplied by the AC power source.

The current limiting unit 3 is coupled to the output side of the LED unit 2, and receives the driving current (iᵣₑ) from the output side of the LED unit 2. In this embodiment, the current limiting unit 3 includes a parallel connection of a bypass switch 31 and a current limiting circuit 32 coupled across the output side of the LED unit 2. The bypass switch 31 has a control end for receiving a control signal (v_{G}), such as a logic signal, such that the bypass switch 31 is operable between an ON-state and an OFF-state in response to the control signal (v_{G}). The current limiting unit 3 is operable so as to permit flow of the driving current (iᵣₑ) through one of the bypass switch 31 and the current limiting circuit 32 such that the current limiting unit 3 has a first conduction impedance when the bypass switch 31 is in the ON-state, and a second conduction impedance larger than the first conduction impedance when the bypass switch 31 is in the OFF-state. In this embodiment, the current limiting circuit 32 includes a resistor (R). In other embodiments, the current limiting circuit 32 can includes at least one LED or diode.

In this embodiment, the control unit 4 is coupled to the control end of the bypass switch 31, is adapted for detecting whether magnitude of the input voltage (vᵢₙ) is greater than a predetermined threshold voltage (Vth), and outputs the control signal (v_{G1}) to the control end of the bypass switch 31 based on the detecting result such that the bypass switch 31 is in the ON-state upon detecting that the magnitude of the input voltage (vᵢₙ) is not greater than the predetermined threshold voltage (Vth) and that the bypass switch 31 is in the OFF-state upon detecting that the magnitude of the input voltage (vᵢₙ) is greater than the predetermined threshold voltage (Vth).

In this embodiment, for the input voltage (vᵢₙ) being the positive half of the sinusoidal signal, the current limiting unit 3 is operable among first, second and third modes based on the control signal (v_{G}) for the bypass switch 31 shown in FIG. 5.

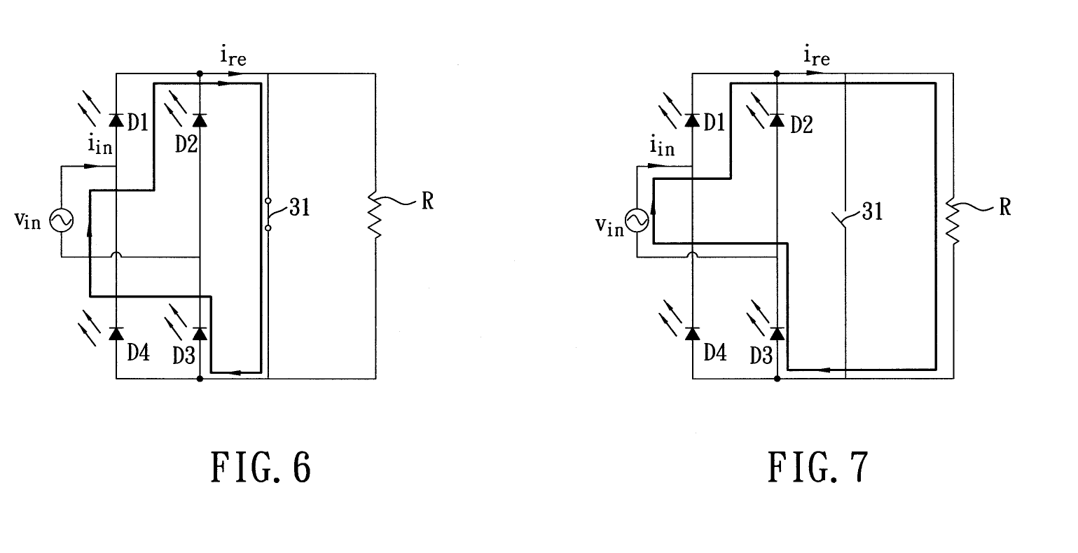

Referring further to FIGS. 5 and 6, the current limiting unit 3 is operated in the first mode during a period from t₀ to t₁. In the first mode, since the magnitude of the input voltage (vᵢₙ) increases and is not greater than the predetermined threshold voltage (Vth), the bypass switch 31 is in the ON-state due to the control signal (v_{G}) having a high level such that the driving current (iᵣₑ) flows through the bypass switch 31. In this case, the bypass switch 31 has a very small equivalent impedance that serves as the first conduction impedance. Therefore, when the magnitude of the input voltage (vᵢₙ) is not greater than the predetermined threshold voltage (Vth), the current limiting unit 3 is regarded as a short circuit.

Referring further to FIGS. 5 and 7, the current limiting unit 3 is operated in the second mode during a period from t₁ to t₂. In the second mode, since the magnitude of the input voltage (vᵢₙ) is greater than the predetermined threshold voltage (Vth), the bypass switch 31 is in the OFF-state due to the control signal (v_{G}) having a low level such that the driving current (iᵣₑ) flows through the resistor (R). In this case, the resistance of the resistor (R) serves as the second conduction impedance and is much larger than the first conduction impedance. Therefore, when the magnitude of the input voltage (vᵢₙ) is greater than the predetermined threshold voltage (Vth), a variation rate of the driving current (iᵣₑ) is reduced as compared to that in the first mode.

Referring further to FIGS. 5 and 6, during a period from t₂ to t₃, the current limiting unit 3 is operated in the third mode. In the third mode, since the magnitude of the input voltage (vᵢₙ) decreases and is not greater than the predetermined threshold voltage (Vth), the bypass switch 31 is in the ON-state due to the control signal (v_{G}) having the high level such that the driving current (iᵣₑ) flows through the bypass switch 31.

Since operation of the current limiting unit 3 for the input voltage (vᵢₙ) being the negative half of the sinusoidal signal is similar to that for the input voltage (vᵢₙ) being the positive half of the sinusoidal signal, details of the same are omitted herein for the sake of brevity.

Therefore, the current limiting unit 3 effectively controls the driving current (iᵣₑ) with variation of the input voltage (vᵢₙ), thereby enhancing the lighting efficiency of the LED unit 2.

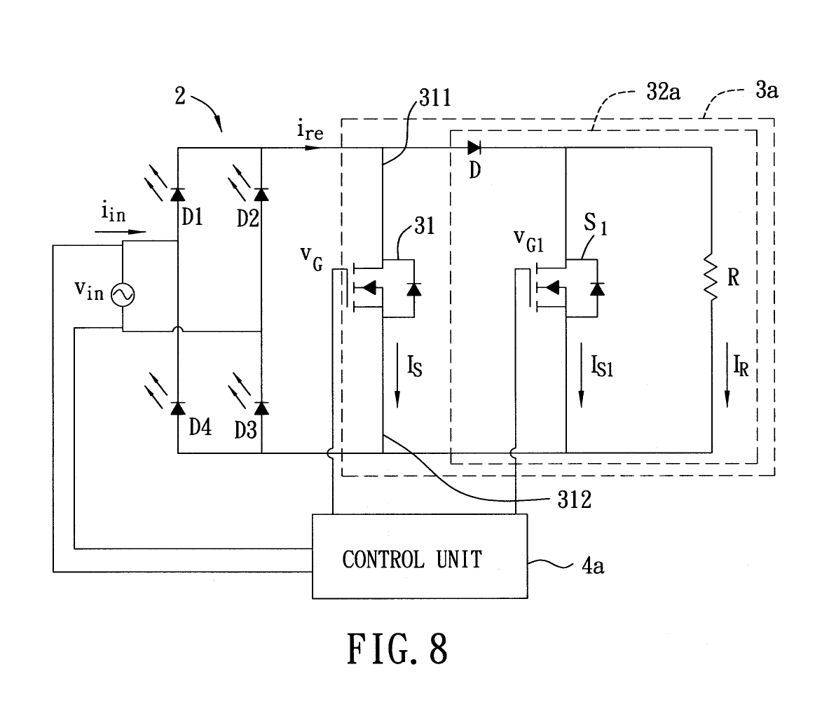

FIG. 8 illustrates the second preferred embodiment of an LED driving device according to this invention, which is a modification of the first preferred embodiment. In this embodiment, the bypass switch 31 has first and second ends 311, 312 coupled across the output side of the LED unit 2.

In this embodiment, the current limiting circuit (32a) of the current limiting unit (3a) includes a series connection of an impedance component and a resistor (R), and a switch (S₁). In this embodiment, the impedance component is a diode (D) that has an anode coupled to the first end 311 of the bypass switch 31, and a cathode. The resistor (R) is coupled between the cathode of the diode (D) and the second end 312 of the bypass switch 31. In other embodiments, the impedance component can be an LED or a resistor. The switch (S₁) is coupled between the cathode of the diode (D) and the second end 312 of the bypass switch 31, and has a control end for receiving a control signal (v_{G1}) such that the switch (S₁) is operable between an ON-state and an OFF-state in response to the control signal (v_{G1}).

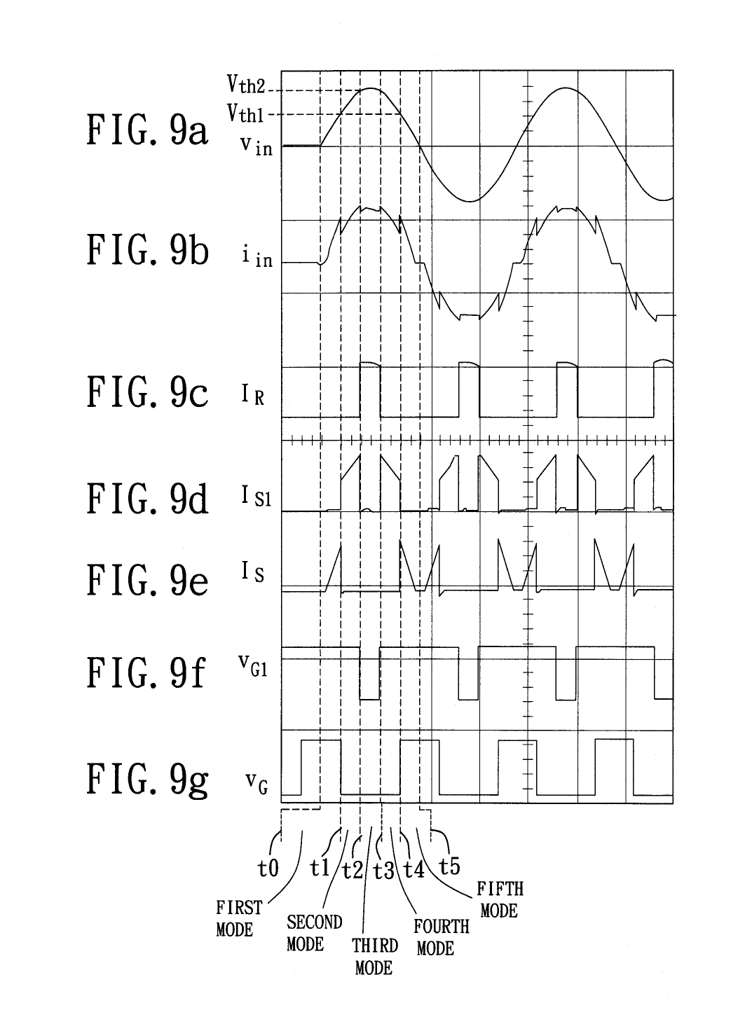

In this embodiment, the control unit (4a) is further coupled to the control end of the switch (S₁), and further outputs the control signal (v_{G1}) to the control end of the switch (S₁) based on the magnitude of the input voltage (vᵢₙ) such that, when the bypass switch 31 is in the OFF-state, i.e., the magnitude of the input voltage (vᵢₙ) is not greater than a first predetermined threshold voltage (Vth1) (see FIG. 9a), the switch (S₁) is operable between the ON-state and the OFF-state in response to the control signal (v_{G1}).

In this embodiment, for the input voltage (vᵢₙ) being the positive half of the sinusoidal signal, the current limiting unit (3a) is operable among first, second, third, fourth and fifth modes based on the control signals (V_{G}, v_{G1}) for the bypass switch 31 and the switch (S₁) shown in FIGS. 9f and 9g.

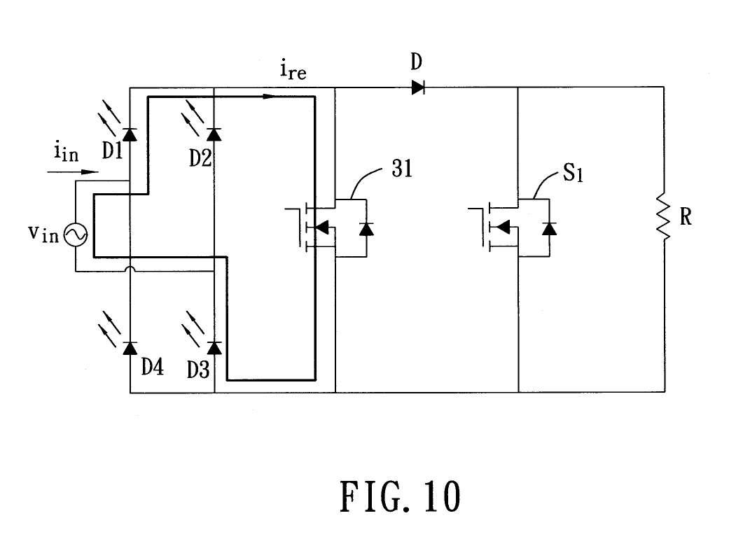

Referring further to FIGS. 9a to 9g, and 10, the current limiting unit (3a) is operated in the first mode during a period from t₀ to t₁. In the first mode, since the magnitude of the input voltage (vᵢₙ) increases and is not greater than the first predetermined threshold voltage (Vth1), the bypass switch 31 is in the ON-state due to the control signal (v_{G}) having a high level such that the driving current (iᵣₑ) is a current (Iₛ) flowing through the bypass switch 31.

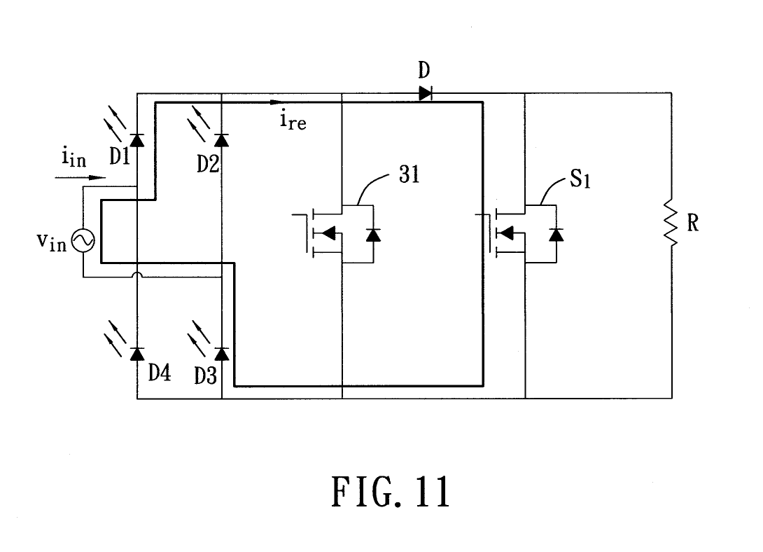

Referring further to FIGS. 9a to 9g, and 11, the current limiting unit (3a) is operated in the second mode during a period from t₁ to t₂. In the second mode, since the magnitude of the input voltage (vᵢₙ) increases, is greater than the first predetermined threshold voltage (Vth1), and is not greater than a second predetermined threshold voltage (Vth2) smaller than the first predetermined threshold voltage (Vth1), the bypass switch 31 is in the OFF-state due to the control signal (v_{G}) having a low level and the switch (S₁) is in the ON-state due to the control signal (v_{G1}) having a high level such that the driving current (iᵣₑ) is a current (Iₛ) flowing through the switch (S1). In this case, due to the presence of the diode (D), the second conduction impedance is greater than the first conduction impedance. Therefore, the increasing rate of the driving current (iᵣₑ) in the second mode is reduced as compared to that in the first mode.

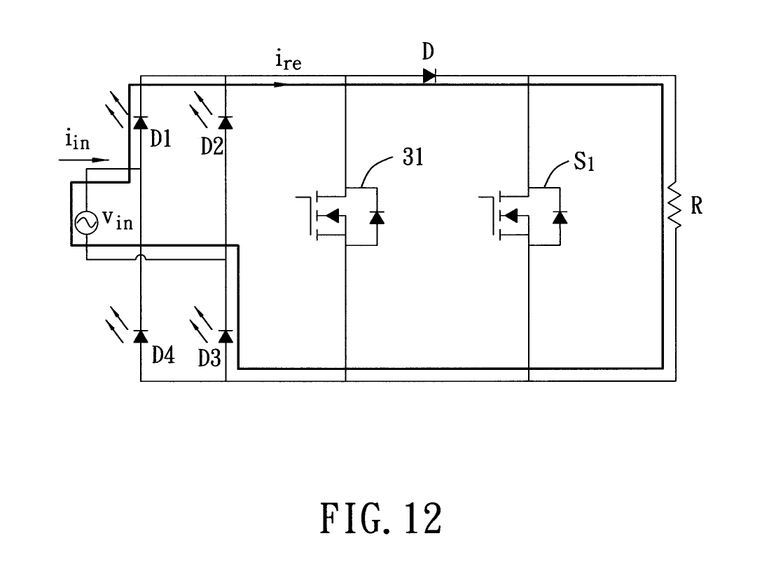

Referring further to FIGS. 9a to 9g, and 12, the current limiting unit (3a) is operated in the third mode during a period from t₂ to t₃. In the third mode, since the magnitude of the input voltage (vᵢₙ) is greater than the second predetermined threshold voltage (Vth2), the bypass switch 31 and the switch (S₁) are in the OFF-state due to the control signals (v_{G}, v_{G1}) having a low level such that the driving current (iᵣₑ), i.e., a current (I_{R}), flows through the diode (D) and the resistor (R). In this case, due to the presence of the diode (D) and the resistor (R), the driving current (iᵣₑ) is gently varied.

Referring further to FIGS. 9a to 9g, and 11, during a period from t₃ to t₄, the current limiting unit (3a) is operated in the fourth mode. In the third mode, since the magnitude of the input voltage (vᵢₙ) decreases, is greater than the first predetermined threshold voltage (Vth1), and is not greater than the second predetermined threshold voltage (Vth2), the bypass switch 31 is in the OFF-state due to the control signal (v_{G}) having a low level and the switch (S₁) is in the ON-state due to the control signal (v_{G1}) having a high level such that the driving current (iᵣₑ) is a current (Iₛ) flowing through the switch (S₁). In this case, the decreasing rate of the driving current (iᵣₑ) is similar to the increasing rate of the same in the second mode.

Referring further to FIGS. 9a to 9g, and 10, during a period from t₄ to t₅, the current limiting unit (3a) is operated in the fifth mode. In the fifth mode, since the magnitude of the input voltage (vᵢₙ) decreases and is not greater than the first predetermined threshold voltage (Vth1), the bypass switch 31 is in the ON-state due to the control signal (v_{G}) having the high level such that the driving current (iᵣₑ) is the current (Iₛ) flowing through the bypass switch 31.

Since operation of the current limiting unit (3a) for the input voltage (vᵢₙ) being the negative half of the sinusoidal signal is similar to that for the input voltage (vᵢₙ) being the positive half of the sinusoidal signal, details of the same are omitted herein for the sake of brevity.

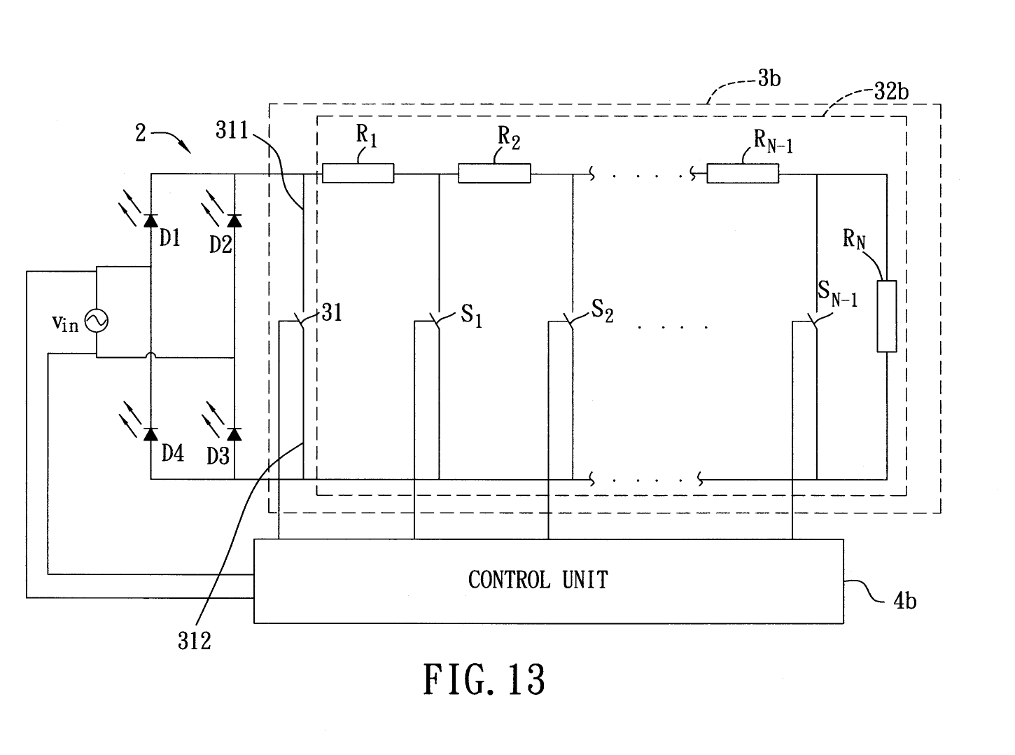

FIG. 13 illustrates the third preferred embodiment of an LED driving device according to this invention, which is a modification of the first preferred embodiment. In this embodiment, the bypass switch 31 has first and second ends 311, 312 coupled across the output side of the LED unit 2.

In this embodiment, the current limiting circuit (32b) of the current limiting unit (3b) includes a series connection of a number (N) of impedance components (R₁, . . . , R_{N}), and a number (N-−1) of switches (S₁, . . . , S_{N-1}) where N≧2. The impedance component (R₁) is coupled to the first end 311 of the bypass switch 31. The impedance component (R_{N}) is coupled to the second end 312 of the bypass switch 31. Each of the switches (S₁, . . . , S_{N-1}) is coupled between a junction of a respective pair of the impedance components (R₁, . . . , R_{N}) and the second end 312 of the bypass switch 31, and has a control end for receiving a control signal such that each of the switches (S₁, . . . , S_{N-1}) is operable between an ON-state and an OFF-state in response to the control signal received thereby.

In this embodiment, the control unit (4b) is further coupled to the control ends of the switches (S₁, . . . , S_{N-1}) and further outputs respectively the control signals to the control ends of the switches (S₁, . . . , S_{N-1}) based on the magnitude of the input voltage (vᵢₙ) such that, when the bypass switch 31 is in the ON-state, i.e., the magnitude of the input voltage (vᵢₙ) is not greater than a first predetermined threshold voltage, an i^{th} one of the switches (S₁, . . . , S_{N-1}) is in the ON-state and first to (i−1)^{th} ones of the switches (S₁, . . . , S_{N-1}) are in the OFF-state, where i≦N−1. Thus, when the bypass switch 31 is in the OFF-state, an impedance of the current limiting circuit (32b) is equal to a sum of impedances of first to i^{th} ones of the impedance components (R₁, . . . , R_{N}).

Therefore, when the bypass switch 31 is in the OFF-state, the impedance of the current limiting circuit (32b) serves as the second conduction impedance of the current limiting unit (3b), and is adjustable through control of the switches (S₁, . . . , S_{N-1}) such that the impedance of the current limiting circuit (32b) corresponds to the magnitude of the input voltage (vᵢₙ). In actual use, initially, each of the bypass switch 31 and the switches (S₁, . . . , S_{N-1}) is set to be in the ON-state. Then, when the magnitude of the input voltage (vᵢₙ) gradually increases to a peak value, the bypass switch 31 and the switches (S₁, . . . , S_{N-1}) are switched from the ON-state to the OFF-state in order. Thereafter, when the magnitude of the input voltage (vᵢₙ) gradually decreases from the peak value, the switches (S_{N-1}, . . . , S₁) and the bypass switch 31 are switched from the OFF-state to the ON-state in order. It is noted that switching of each of the bypass switch 31 and the switches (S₁, . . . , S_{N-1}) is performed based on a corresponding threshold voltage.

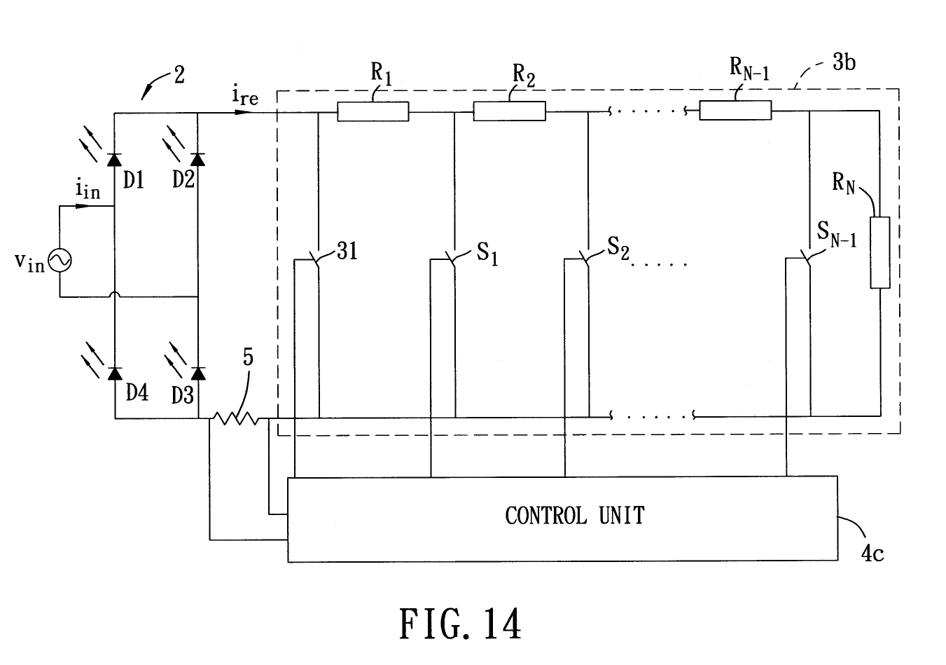

FIG. 14 illustrates the fourth preferred embodiment of an LED driving device according to this invention, which is a modification of the third preferred embodiment. Unlike the third preferred embodiment, the LED driving device further includes a current detecting resistor 5 coupled between the output side of the LED unit 2 and the bypass switch 31 for permitting flow of the driving current (iᵣₑ) therethrough, and having a predetermined resistance.

In this embodiment, the control unit (4c) detects a voltage across the current detecting resistor 5 to obtain the driving current (iᵣₑ), and outputs respectively the control signals to the control ends of the bypass switch 31 and the switches (S₁, . . . , S_{N-1}) based on magnitude of the driving current (iᵣₑ) such that, when the bypass switch 31 is in the OFF-state, the impedance of the current limiting circuit corresponds to the magnitude of the driving current (iᵣₑ). In actual use, initially, each of the bypass switch 31 and the switches (S₁, . . . , S_{N-1}) is set to be in the ON-state. Then, when the magnitude of the driving current (iᵣₑ) gradually increases to a peak value, the bypass switch 31 and the switches (S₁, . . . , S_{N-1}) are switched from the ON-state to the OFF-state in order. Thereafter, when the magnitude of the driving current (iᵣₑ) gradually decreases from the peak value, the switches (S_{N-1}, . . . , S₁) and the bypass switch 31 are switched from the OFF-state to the ON-state in order. It is noted that switching of each of the bypass switch 31 and the switches (S₁, . . . , S_{N-1}) is performed based on a corresponding threshold current.

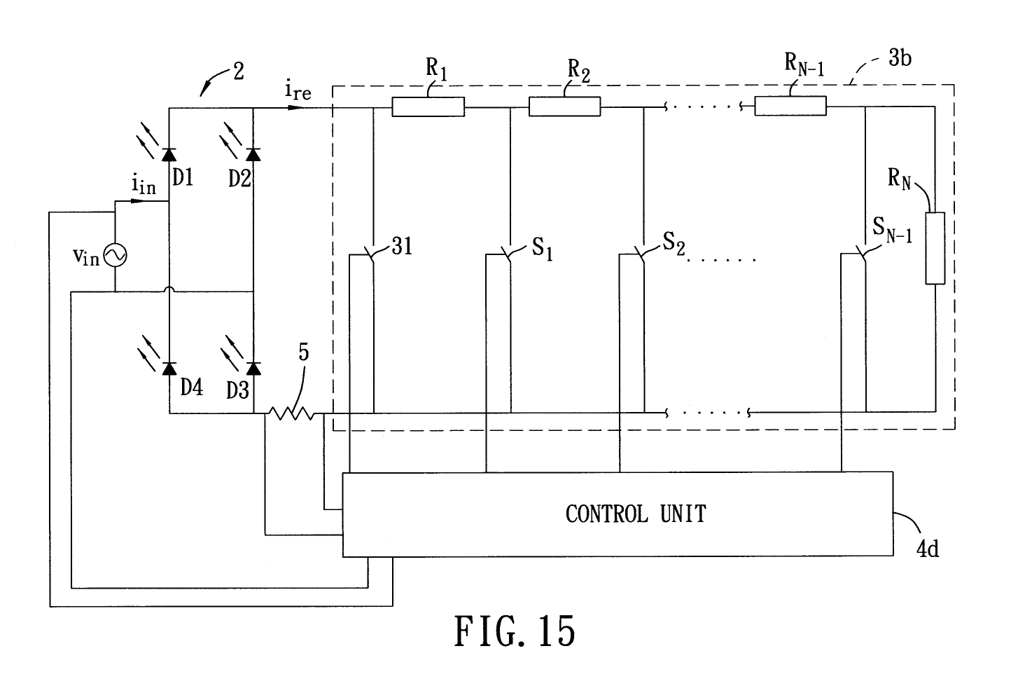

FIG. 15 illustrates the fifth preferred embodiment of an LED driving device according to this invention, which is a modification of the fourth preferred embodiment. Unlike the third and fourth preferred embodiments, the control unit (4d) further obtains an input power based on the driving current (iᵣₑ) and the input voltage (vᵢₙ) detected thereby, and outputs respectively the control signals to the control ends of the bypass switch 31 and the switches (S₁, . . . , S_{N-1}) based on magnitude of the input power such that, when the bypass switch 31 is in the OFF-state, the impedance of the current limiting circuit corresponds to the magnitude of the input power. In actual use, initially, each of the bypass switch 31 and the switches (S₁, . . . , S_{N-1}) is set to be in the ON-state. Then, when the magnitude of the driving current (iᵣₑ) gradually increases to a peak value, the bypass switch 31 and the switches (S₁, . . . , S_{N-1}) are switched from the ON-state to the OFF-state in order. Thereafter, when the magnitude of the driving current (iᵣₑ) gradually decreases from the peak value, the switches (S_{N-1}, . . . , S₁) and the bypass switch 31 are switched from the OFF-state to the ON-state in order. It is noted that switching of each of the bypass switch 31 and the switches (S₁, . . . , S_{N-1}) is performed based on a corresponding threshold power.

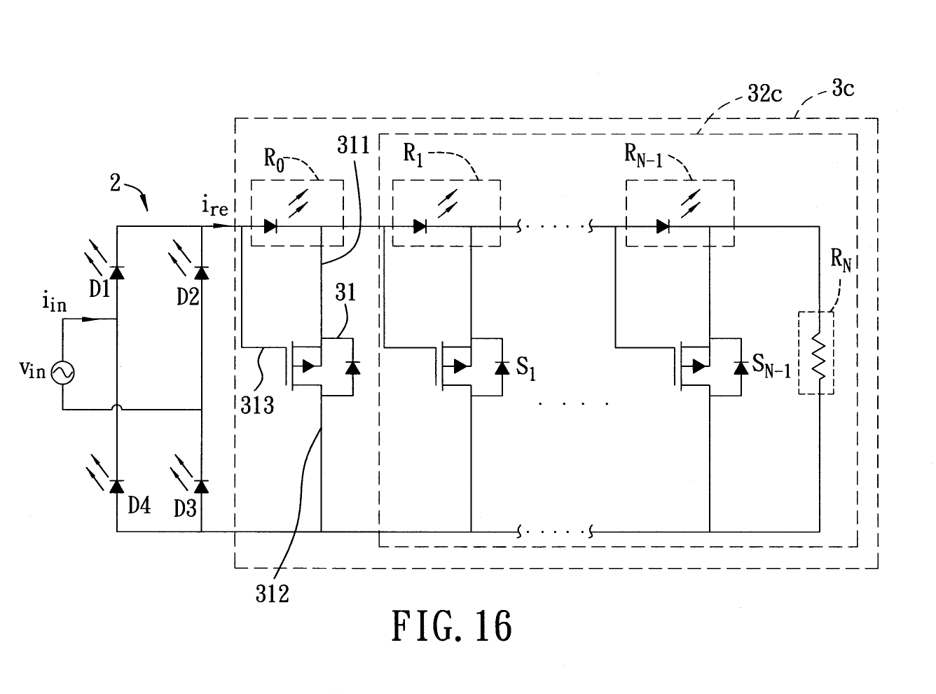

FIG. 16 illustrates the sixth preferred embodiment of an LED driving device according to this invention, which is a modification of the first preferred embodiment. Unlike the first preferred embodiment, the control unit is omitted.

In this embodiment, the bypass switch 31 is a transistor, such as a depletion PMOSFET, that has a first end 311, and a second end 312 and a control end 313 coupled across the output side of the LED unit 2.

The current limiting unit (3c) further includes an impedance component (R₀), such as an LED, coupled between the control end 313 and the first end 311 of the bypass switch 311. The bypass switch 31 is operable between the ON-state and the OFF-state in response to a voltage across the impedance component (R₀).

In this embodiment, the current limiting circuit (32c) includes a series connection of a number (N) of impedance components (R₁, . . . , R_{N}), and a number (N−1) of switches (S₁, . . . , S_{N-1}), where N≧2. The impedance component (R₁) is coupled to the first end 311 of the bypass switch 31. The impedance component (R_{N}) is coupled to the second end 312 of the bypass switch 31. In this embodiment, each of the impedance components (R₁, . . . , R_{N-1}) is an LED, and the impedance component (R_{N}) is a resistor. Each of the switches (S₁, . . . , S_{N-1}) is a transistor, such as a depletion PMOSFET, is coupled between a junction of a respective pair of the impedance components (R₁, . . . , R_{N}) and the second end 312 of the bypass switch 31, and has a control end. The control end of the first switch (S₁) is coupled to the first end 311 of the bypass switch 31. The control end of an i^{th} one of said switches being coupled to a junction of (i−1)^{th} and i^{th} ones of the impedance components (R₁, . . . , R_{N}), where 3≦i≦N−1. A j^{th} one of the switches (S₁, . . . , S_{N-1}) is operable between an ON-state and an OFF-state in response to a voltage across a j^{th} one of the impedance components (R₁, . . . , R_{N}), where 1≦j≦N−1.

Therefore, when the bypass switch 31 is in the OFF-state, the impedance of the current limiting circuit (32c) serves as the second conduction impedance of the current limiting unit (3c), and is adjustable through control of the switches (S₁, . . . , S_{N-1}) such that the impedance of the current limiting circuit (32c) corresponds to the magnitude of the input voltage (vᵢₙ). In actual use, initially, each of the bypass switch 31 and the switches (S₁, . . . , S_{N-1}) is set to be in the ON-state. Then, when the magnitude of the input voltage (vᵢₙ) gradually increases to a peak value, the bypass switch 31 and the switches (S₁, . . . , S_{N-1}) are switched from the ON-state to the OFF-state in order. Thereafter, when the magnitude of the input voltage (vᵢₙ) gradually decreases from the peak value, the switches (S_{N-1}, . . . , S₁) and the bypass switch 31 are switched from the OFF-state to the ON-state in order.

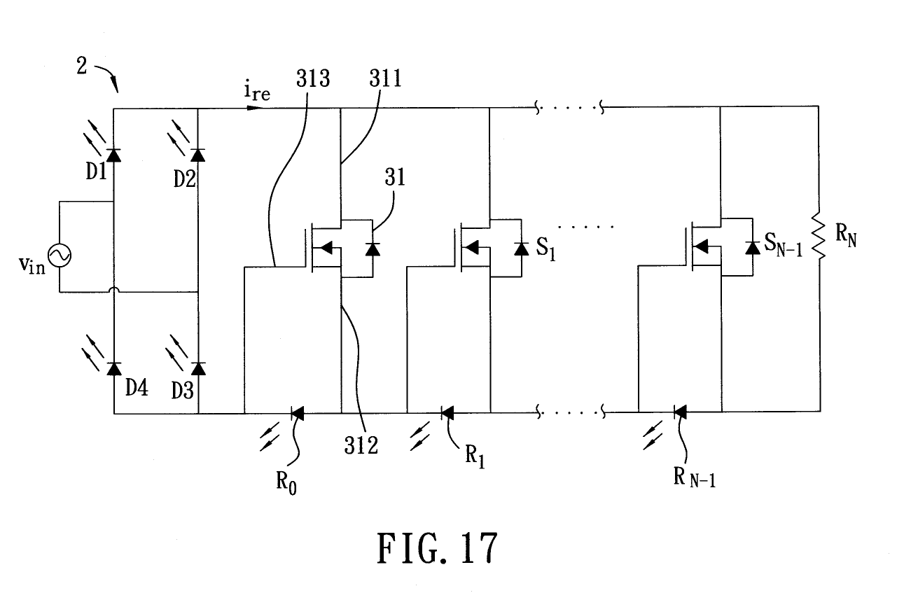

FIG. 17 illustrates a first variation of the sixth preferred embodiment, wherein each of the bypass switch 31 and the switches (S₁, . . . , S_{N-1}) is a depletion NMOSFET. The first end 311 and the control end 313 of the bypass switch 31 are coupled across the output side of the LED unit 2. The impedance component (R₀) is coupled between the control end 313 and the second end 312 of the bypass switch 31. The impedance component (R₁) is coupled to the second end 312 of the bypass switch 31. The impedance component (R_{N}) is coupled to the first end 311 of the bypass switch 31. Each of the switches (S₁, . . . , S_{N-1}) is coupled between a junction of a respective pair of the impedance components (R₁, . . . , R_{N}) and the first end 311 of the bypass switch 31. The control end of the first switch (S₁) is coupled to the second end 312 of the bypass switch 31.

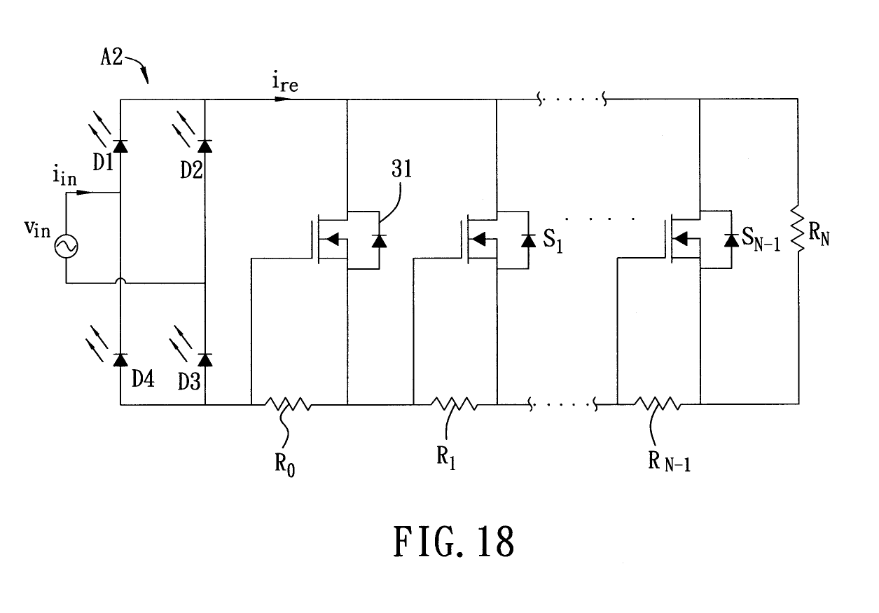

FIG. 18 illustrates a second variation of the sixth preferred embodiment that differs from the first variation of FIG. 17 in that each of the impedance components (R₀, R₁, . . . , R_{N-1}) is a resistor.

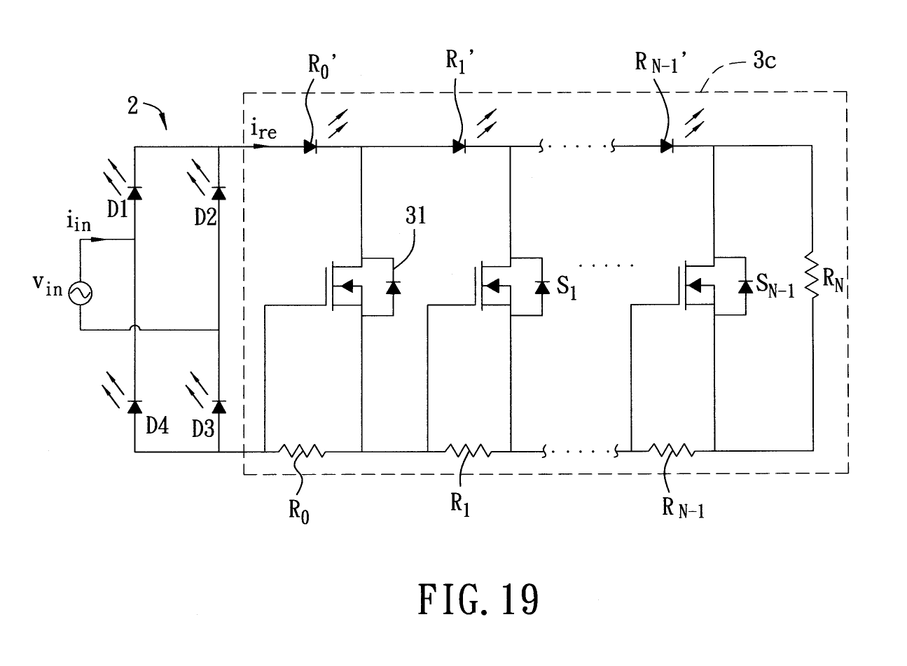

FIG. 19 illustrates a third variation of the sixth preferred embodiment that differs from the second variation of FIG. 18 in that the current limiting unit (3c) further includes a number (N) of impedance components ((R₀′, R₁′, . . . , R_{N-1}′), each of which is an LED.

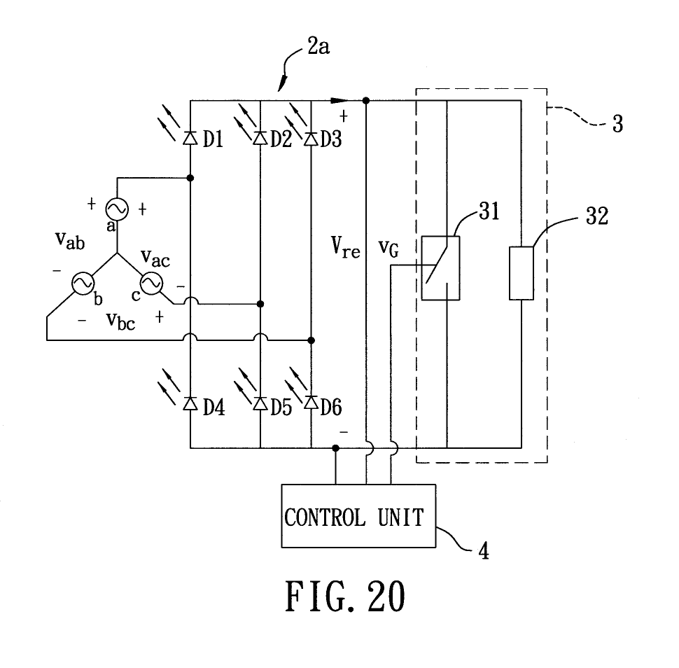

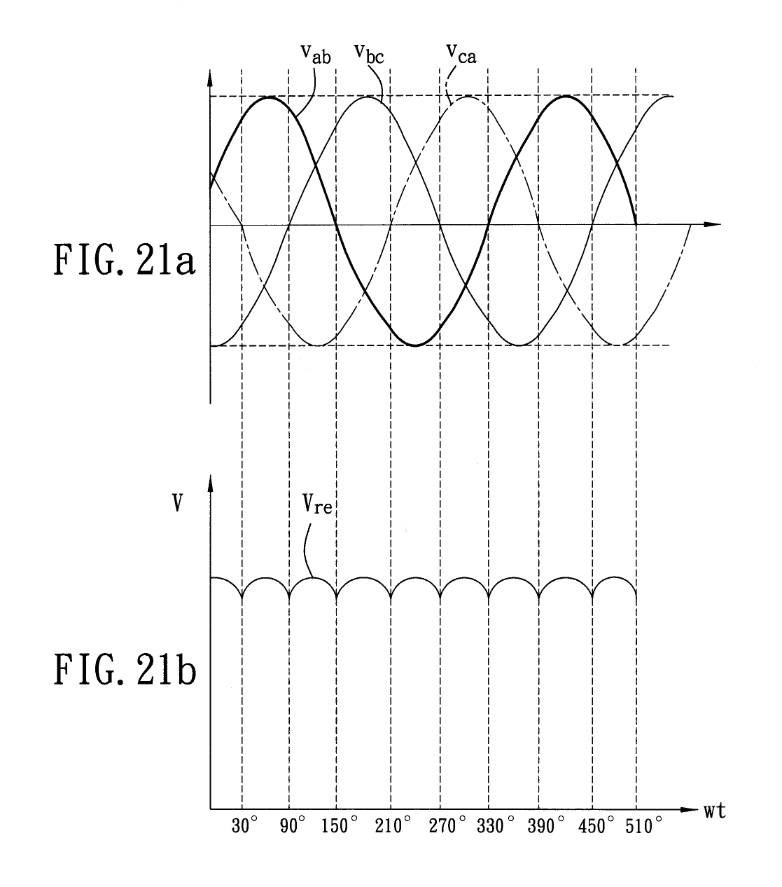

FIG. 20 illustrates the seventh preferred embodiment of an LED driving device according to this invention, which is a modification of the first preferred embodiment. In this embodiment, the input voltage is a three-phase AC voltage that includes a first phase voltage (v_{ab}), a second phase voltage (v_{bc}) and a third phase voltage (v_{ac}) as shown in FIG. 21a.

The LED unit (2a) is adapted for rectifying the input voltage, outputs at the output side the driving current (iᵣₑ) that corresponds to the input voltage rectified thereby. In this embodiment, the LED unit (2a) includes three series-connected units connected in parallel. Each of the series-connected units includes first and second LEDs (D1, D4, D2, D5, D3, D6). A common node between an anode of the first LED (D1) and a cathode of the second LED (D4) is adapted to receive the first phase voltage (v_{ab}). A common node between an anode of the first LED (D2) and a cathode of the second LED (D5) is adapted to receive the second phase voltage (v_{bc}). A common node between an anode of the first LED (D3) and a cathode of the second LED (D6) is adapted to receive the third phase voltage (v_{ac}). A first common node among cathodes of the first LEDs (D1, D2, D3) and a second common node among anodes of the second LEDs (D4, D5, D6) constitute the output side of the LED unit (2a). Thus, the LED unit (2a) outputs a voltage (Vᵣₑ) at the output side based on the input voltage, as shown in FIG. 21b.

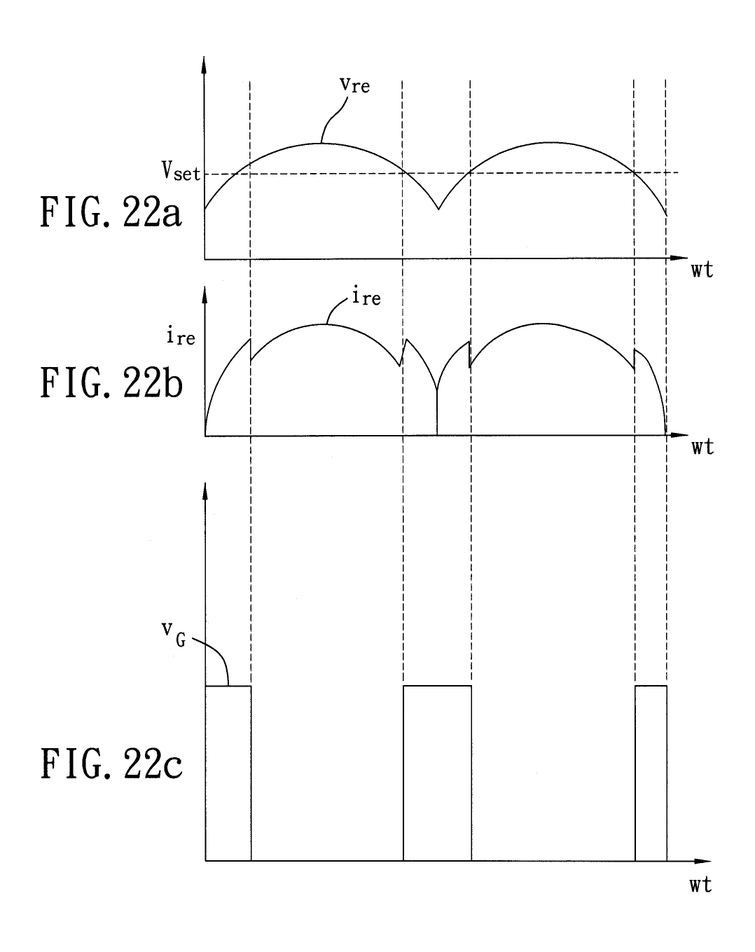

In this embodiment, the control unit 4 detects a voltage (Vᵣₑ) across the output side of the LED unit (2a), and outputs a control signal (v_{G}) to the control end of the bypass switch 31 based on the voltage (Vᵣₑ) such that the bypass switch 31 is operated in the ON-state due to the control signal (V_{G}) having a high level (see FIG. 22c) upon detecting that the voltage (vᵣₑ) is not greater than a predetermined threshold voltage (Vₛₑₜ) (see FIG. 22a), and that the bypass switch 31 is operated in the OFF-state due to the control signal (v_{G}) having a low level (see FIG. 22c) upon detecting that the voltage (vᵣₑ) is greater than a predetermined threshold voltage (Vₛₑₜ) (see FIG. 22a).

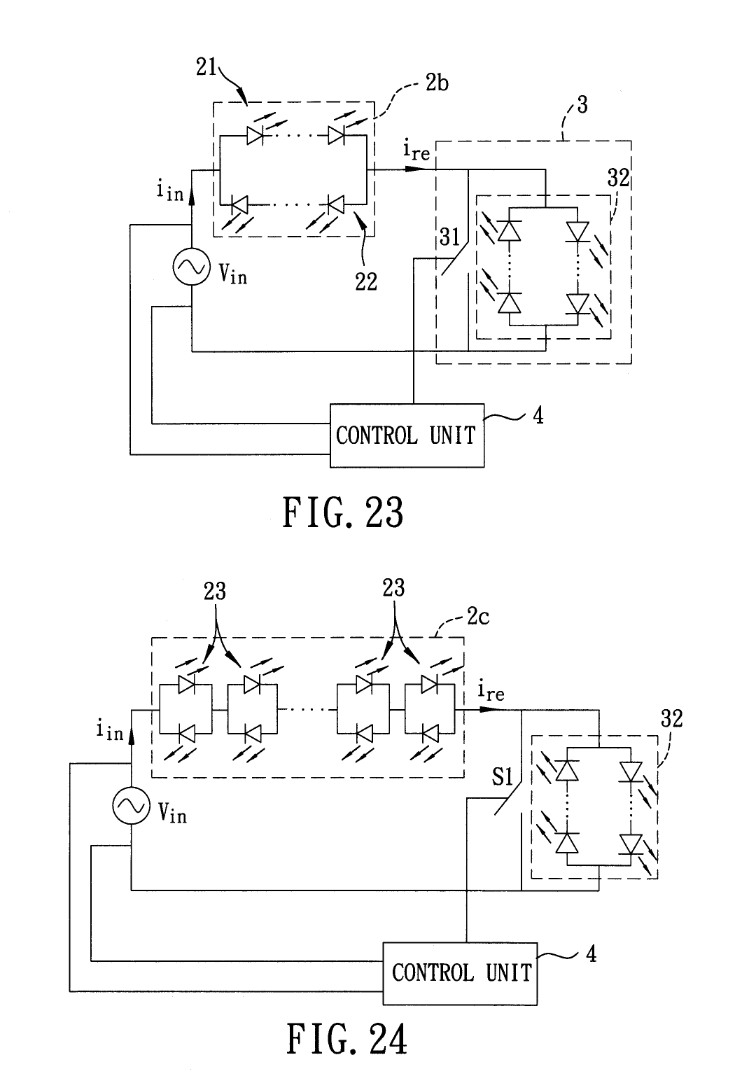

FIG. 23 illustrates the eighth preferred embodiment of an LED driving device according to this invention, which is a modification of the first preferred embodiment. In this embodiment, the LED unit (2b) includes first and second series-connected units 21, 22 connected in parallel. Each of the first and second series-connected units 21, 22 includes a plurality of LEDs. The LEDs of the first series-connected unit 21 conduct when the input voltage is positive. The LEDs of the second series-connected unit 22 conduct when the input voltage is negative. Furthermore, the current limiting circuit 32 has the same configuration as that of the LED unit (2b).

FIG. 24 illustrates a first variation of the eighth preferred embodiment, wherein the LED unit (2c) includes a plurality of parallel-connected units 23 connected in series. Each of the parallel-connected units 23 includes first and second LEDs. For each parallel-connected unit 23, an anode of one of the first and second LEDs is coupled to a cathode of the other one of the first and second LEDs.

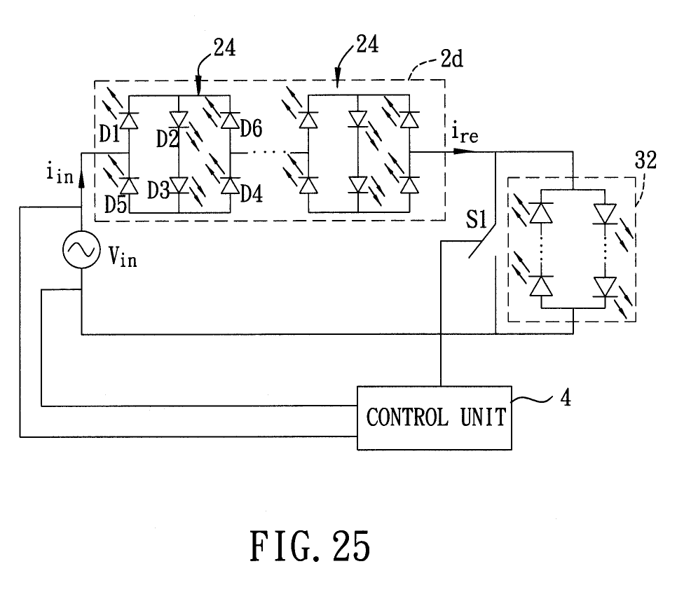

FIG. 25 illustrates a second variation of the eighth preferred embodiment, wherein the LED unit (2d) includes a plurality of units 24 connected in series. Each unit includes first to fourth LEDs (D1, D2, D3, D4) connected in series, a fifth LED (D5) having an anode coupled to a cathode of the third LED (D3), and a cathode coupled to an anode of the first LED (D1), and a sixth LED (D6) having an anode coupled to a cathode of the fourth LED (D6), and a cathode coupled to an anode of the second LED (D2).

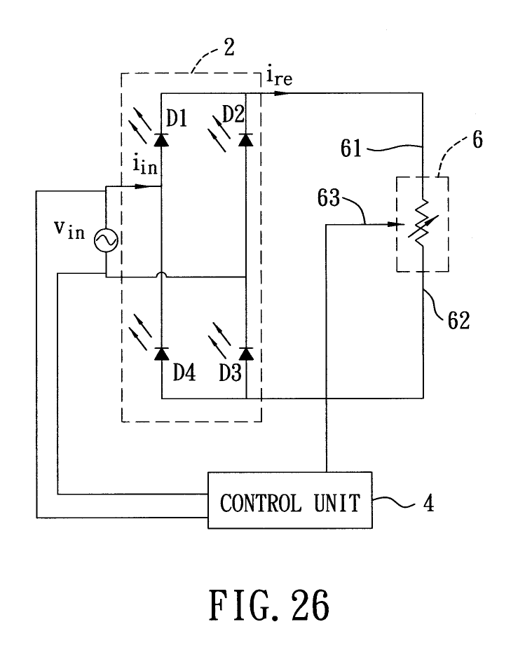

FIG. 26 illustrates the ninth preferred embodiment of an LED driving device according to this invention, which is a modification of the first preferred embodiment. Unlike the first preferred embodiment, the LED driving device includes a variable impedance unit 6 that serves as the current limiting unit in first preferred embodiment. The variable impedance unit 6 is coupled across the output side of the LED unit 2, permits flow of the driving current (iᵣₑ) therethrough, and has a conduction impedance that is variable based on an adjusting signal, such as an analog signal.

In this embodiment, the variable impedance unit 6 includes a variable resistor, and has first and second ends 61, 62 coupled across the output side of the LED unit 2 for receiving the driving current (iᵣₑ), and a control end 63 for receiving the adjusting signal. It is noted that, in other embodiments, the variable impedance unit 6 can include a MOSFET or a BJT.

In this embodiment, the control unit 4 is adapted for detecting magnitude of the input voltage (vᵢₙ), and generates the adjusting signal based on the magnitude of the input voltage (vᵢₙ) detected thereby. Therefore, the driving current (iᵣₑ) is appropriately adjusted through adjustment of the conduction impedance of the variable impedance unit 6 based on the input voltage (vᵢₙ), thereby enabling stable lighting of the LED unit 2.

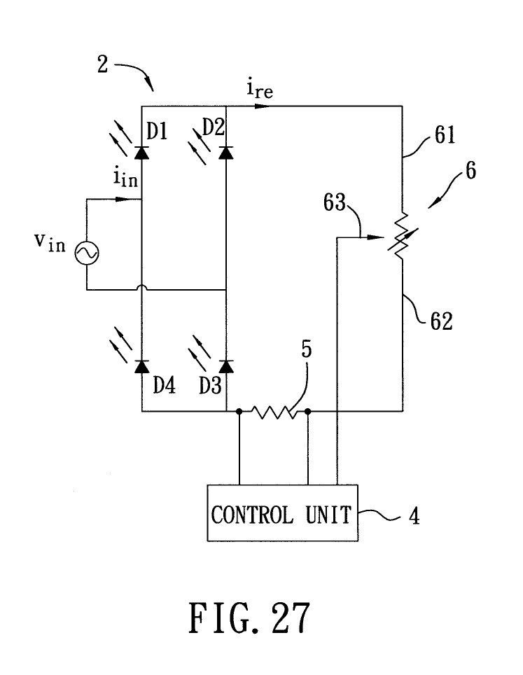

FIG. 27 illustrates the tenth preferred embodiment of an LED driving device according to this invention, which is a modification of the ninth preferred embodiment. In this embodiment, the LED driving device further includes a current detecting resistor 5 coupled between the output side of the LED unit 2 and the second end 62 of the variable impedance unit 6 and having a predetermined resistance.

In this embodiment, the control unit 4 detects a voltage across the current detecting resistor 5 to obtain the driving current (iᵣₑ), and generates the adjusting signal based on the driving current (iᵣₑ).

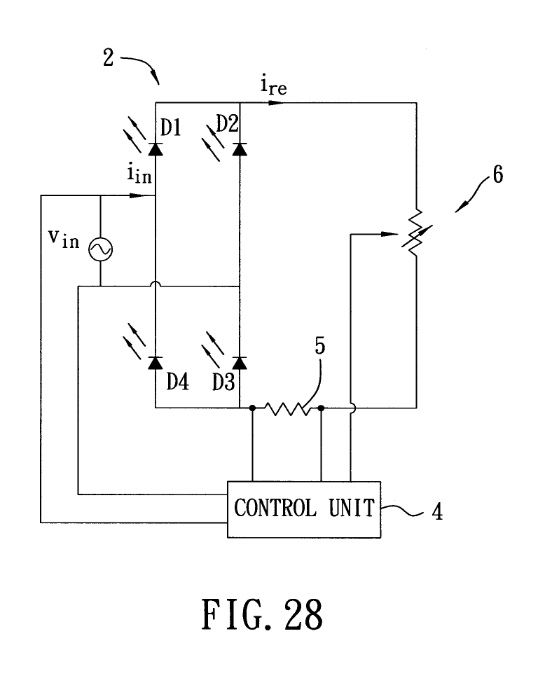

FIG. 28 illustrates the eleventh preferred embodiment of an LED driving device according to this invention, which is a modification of the tenth preferred embodiment. In this embodiment, the control unit 4 further obtains an input power based on the driving current (iᵣₑ) and the input voltage (vᵢₙ) detected thereby, and generates the adjusting signal based on magnitude of the input power.

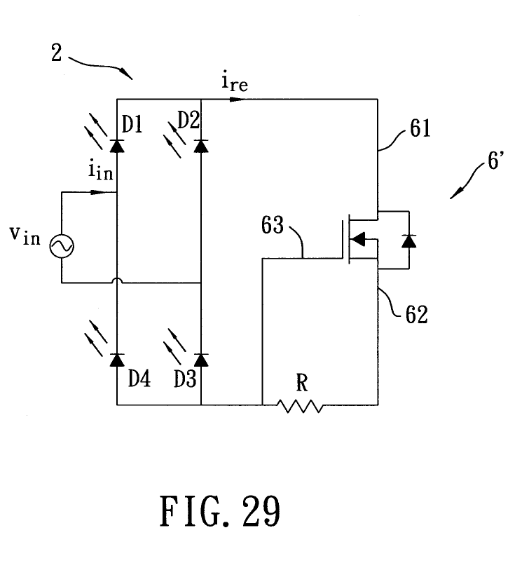

FIG. 29 illustrates the twelfth preferred embodiment of an LED driving device according to the present invention, which is a modification of the ninth preferred embodiment. In this embodiment, the control unit is omitted.

The variable impedance unit 6′ has first and second ends 61, 62, and a control end 63. The first end 61 and the control end 63 are coupled to the output side of the LED unit 2. The control end 63 receives the adjusting signal.

In this embodiment, the LED driving device further includes an impedance component (R), such as a resistor, coupled between the control end 63 and the second end 62 of the variable impedance unit 6′. The adjusting signal varies with magnitude of the input voltage (vᵢₙ) and corresponds to a voltage across the impedance component (R).

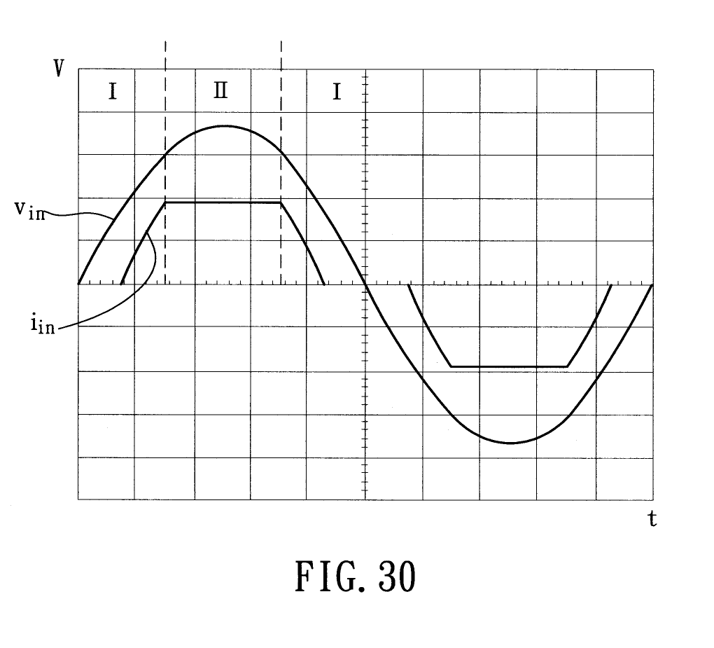

In this embodiment, the variable impedance unit 6′ is an NMOSFET. Referring to FIG. 30, when the magnitude of the input voltage (vᵢₙ) gradually increases from zero, the input current (iᵢₙ) gradually increases such that a gate-source voltage (V_{GS}) of the NMOSFET decreases. As a result, operation of the NMOSFET comes from the ohmic region (I) into the saturation region (II), thereby clamping the input current (iᵢₙ) to a certain value. When the magnitude of the input voltage (vᵢₙ) gradually decreases from a peak value, operation of the NMOSFET comes from the saturation region (II) into the ohmic region (I).

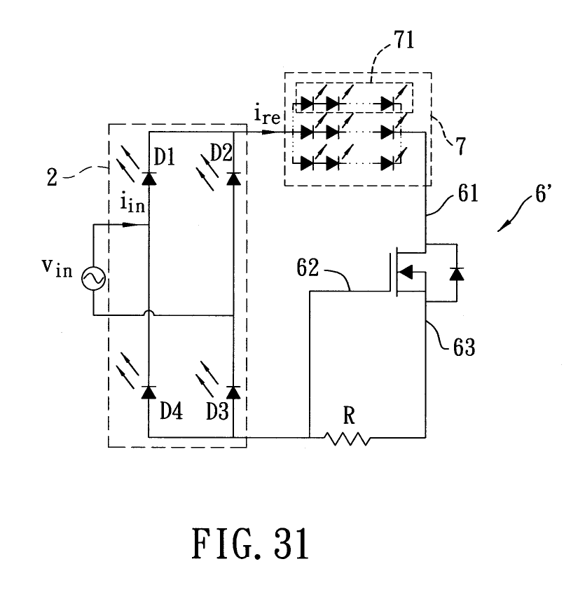

FIG. 31 illustrates the thirteenth preferred embodiment of an LED driving device according to the present invention, which is a modification of the twelfth preferred embodiment. Unlike the twelfth preferred embodiment, the LED driving device further includes a current limiting circuit 7 that is coupled between the output side of the LED unit 2 and the first end 61 of the variable impedance unit 6′.

In this embodiment, the current limiting circuit 7 includes a plurality of series-connected units 71 connected in parallel. Each series-connected unit 71 includes a plurality of impedance components, such as LEDs. In other embodiments, the impedance components can be diodes or resistors.

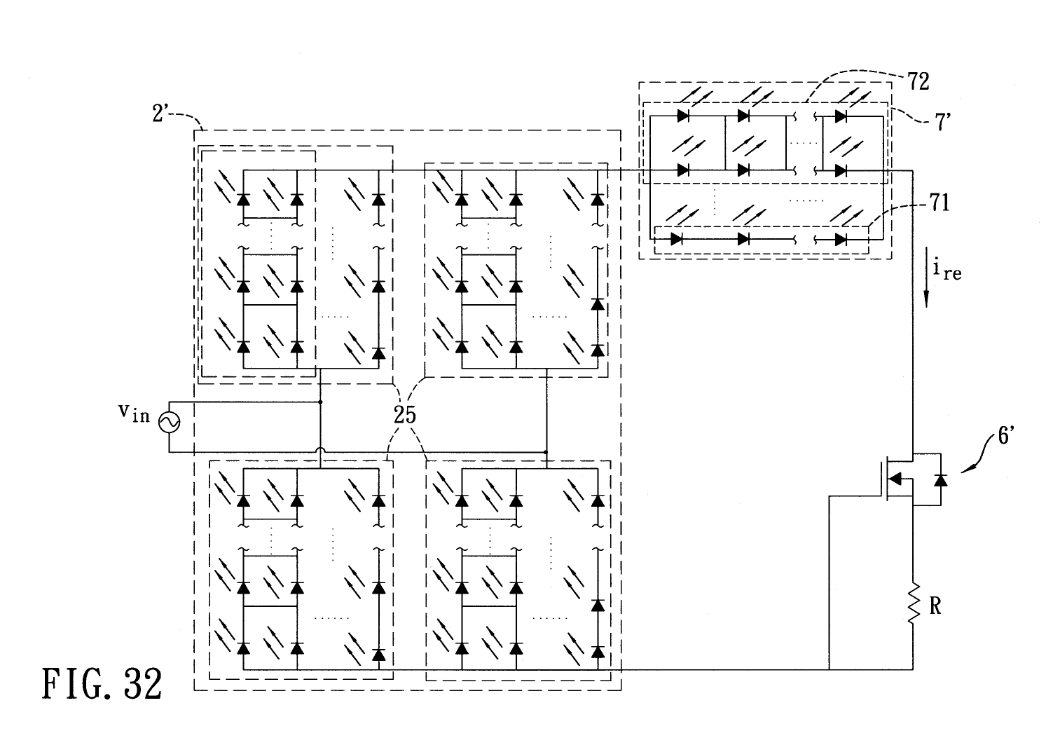

FIG. 32 illustrates the fourteenth preferred embodiment of an LED driving device according to the present invention, which is modification of the thirteenth preferred embodiment. In this embodiment, the current limiting circuit 7′ further includes a first series-connected unit 72 connected in parallel to the series-connected units 71. The first series-connected unit 72 includes a plurality of impedance component units each including two LEDs connected in parallel.

Furthermore, in this embodiment, the LED unit 2′ includes four current limiting circuits 25 that are configured as abridge rectifier adapted for rectifying the input voltage (vᵢₙ) and for outputting at the output side the driving current (iᵣₑ). Each current limiting circuit 25 has the same configuration as that of the current limiting circuit 7′.

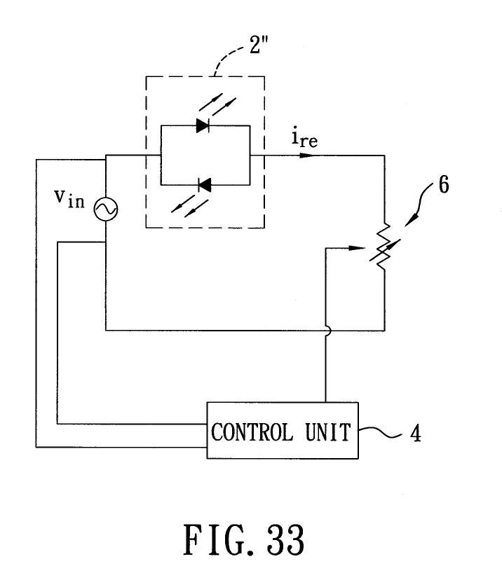

FIG. 33 illustrates the fifteenth preferred embodiment of an LED driving device according to the present invention, which is modification of the tenth preferred embodiment. In this embodiment, the LED unit 2″ includes first and second LEDs coupled in parallel, where the first LED conducts when the input voltage (vᵢₙ) is positive, and the second LED conducts when the input voltage (vᵢₙ) is negative.

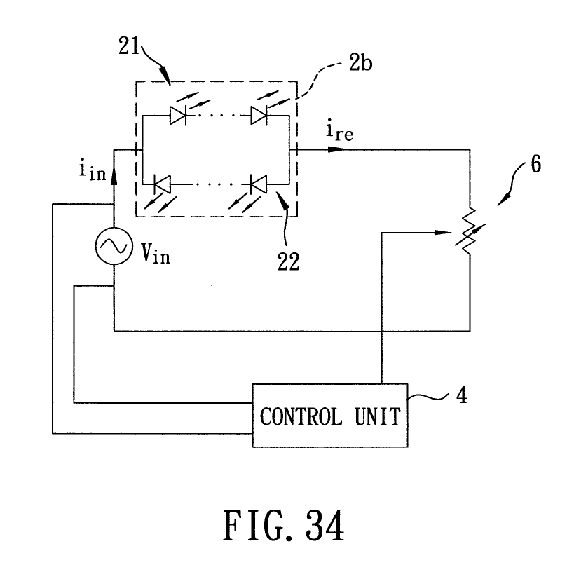

FIG. 34 illustrates a first variation of the fifteenth preferred embodiment, wherein the LED unit (2b) is the same as that in the eighth preferred embodiment of FIG. 23.

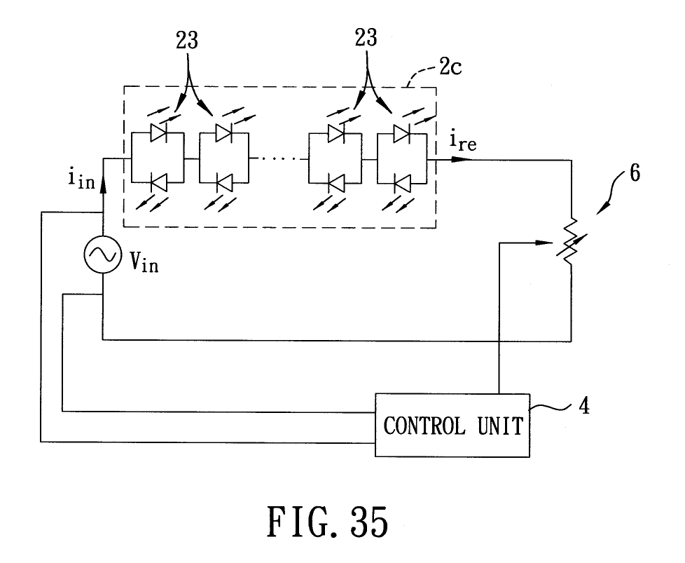

FIG. 35 illustrates a second variation of the fifteenth preferred embodiment, wherein the LED unit (2c) is the same as that in the first variation of the eighth preferred embodiment of FIG. 24.

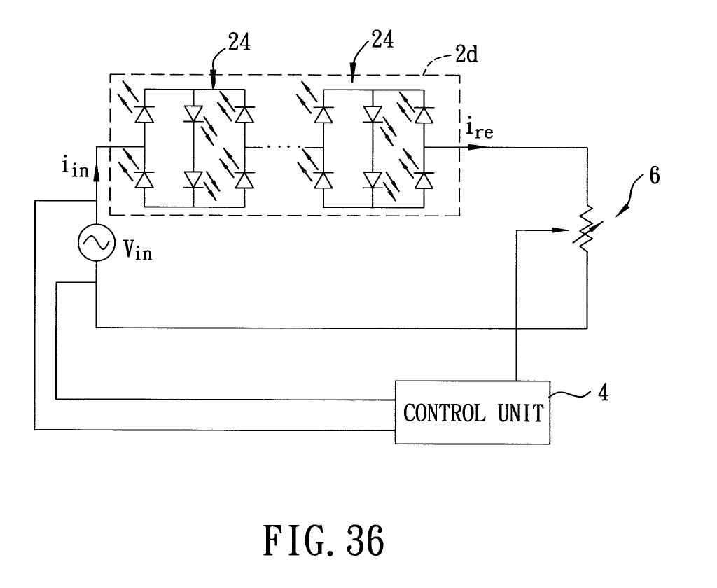

FIG. 36 illustrates a third variation of the fifteenth preferred embodiment, wherein the LED unit (2d) is the same as that in the second variation of the eighth preferred embodiment of FIG. 25.

The following are some of the advantages attributed to the LED driving device of the present invention:

1. The LED driving device of the present invention has a relatively simple structure, thereby reducing fabrication costs.

2. The current limiting unit 3, (3a, 3b, 3c) can be controlled by the control signal (s) in the form of one of a digital signal and an analog signal such that the increasing rate of the input current (iᵢₙ) can be limited or adjusted to enhance the lighting efficiency of the LED unit 2, 2′, 2″, (2a, 2b, 2c, 2d).

3. The number of the LEDs connected in series in the LED unit 2, 2′, 2″, (2a, 2b, 2c, 2d) can be determined based on a required power factor so as to conform to a desired specification. For example, when it is required to have a lower power factor and a stable lighting efficiency, the number of the LEDs connected in series in the LED unit 2, 2′, 2″, (2a, 2b, 2c, 2d) is increased so as to increase the conduction angle.

4. The variable impedance unit 6, 6′ can clamp the driving current (iᵣₑ) to a predetermined current, and can stabilize light output of each LED.

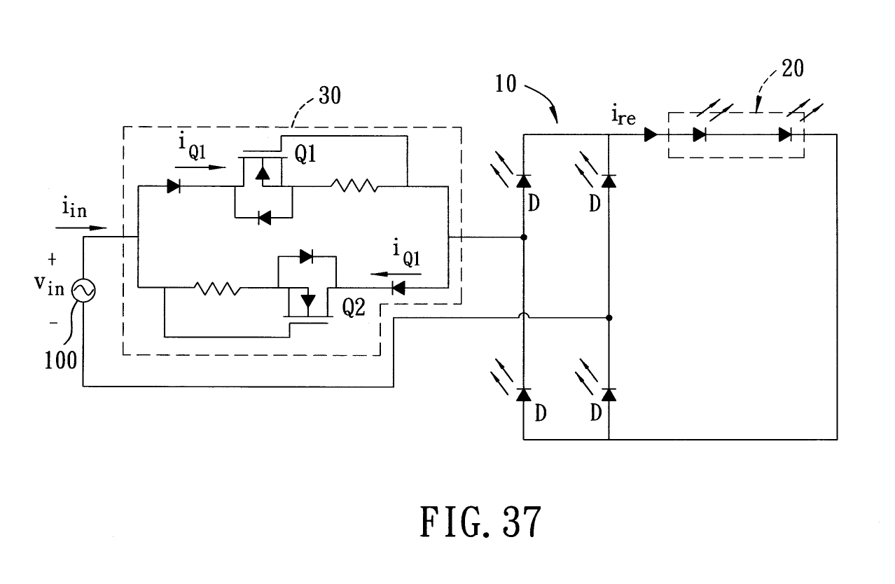

Referring to FIG. 37, the sixteenth preferred embodiment of an LED driving device according to the present invention is shown to include a bridge rectifier 10, an LED unit 20, and a current limiting unit 30.

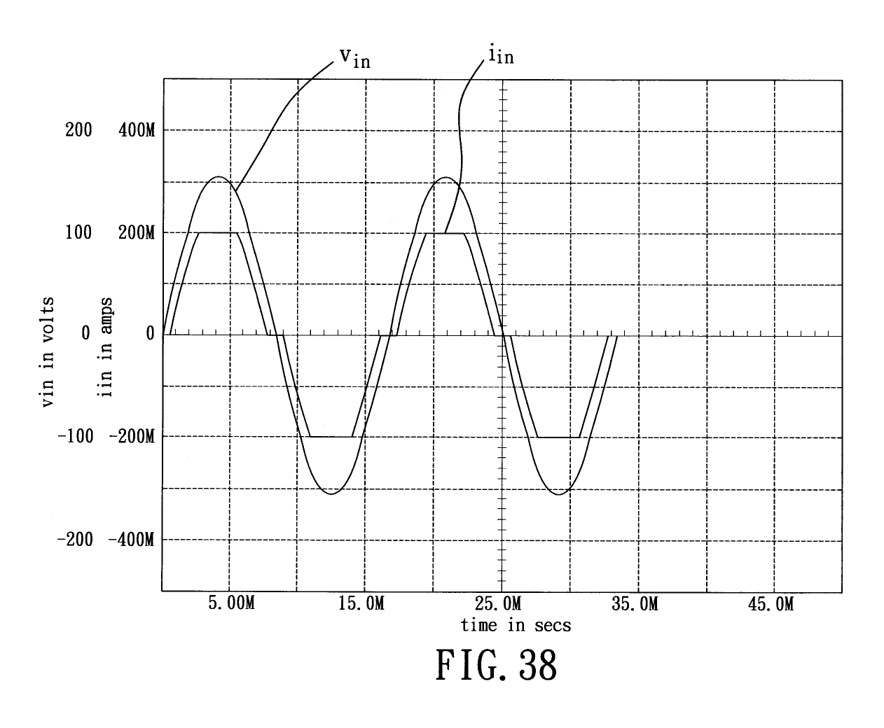

The bridge rectifier 10 has an input side adapted to receive an external AC input voltage (vᵢₙ) from an AC power source 100, and an output side. In this embodiment, the input voltage (vᵢₙ) is a sinusoidal signal, as shown in FIG. 38. The bridge rectifier 10 consists of four LEDs (D). In other embodiments, the bridge rectifier 10 can consist of four diodes or combination of diodes and LEDs.

The LED unit 20 is coupled across the output side of the bridge rectifier 10. In this embodiment, the LED unit 20 includes a series connection of LEDs.

The current limiting unit 30 is adapted to be coupled between the AC power source 100 and the input side of the bridge rectifier 10, and includes two NMOSFETs (Q1, Q2), such as depletion NMOSFETs, coupled inversely in parallel. The current limiting unit 30 is operable so as to permit flow of a driving current (iᵣₑ) that is not greater than a predetermined threshold current through the bridge rectifier 10 to the LED unit 20. When the input voltage (vᵢₙ) is a positive half of the sinusoidal signal, the NMOSFET (Q1) conducts. When the input voltage (vᵢₙ) is a negative half of the sinusoidal signal, the NMOSFET (Q2) conducts. The driving current (iᵣₑ) corresponds to an input current (iᵢₙ) supplied by the AC power source 100.

Referring to FIG. 38, when the magnitude of the input voltage (vᵢₙ) gradually increases from zero, the input current (iᵢₙ) gradually increases such that a gate-source voltage (V_{GS}) of the NMOSFET decreases. As a result, operation of the NMOSFET (Q1) comes from the ohmic region into the saturation region, thereby clamping the input current (iᵢₙ) to the predetermined threshold current. When the magnitude of the input voltage (vᵢₙ) gradually decreases from a peak value, operation of the NMOSFET (Q1) comes from the saturation region into the ohmic region. Therefore, when each of the NMOSFETs (Q1, Q2) is operated in the ohmic region, it is regarded as a short circuit. On the other hand, when each of the NMOSFETs (Q1, Q2) is operated in the saturation region, it is regarded as a variable impedance. Since the magnitude of the input current (iᵢₙ) represents the driving current (iᵣₑ), the driving current (iᵣₑ) can be effectively clamped to the predetermined threshold current when the magnitude of the input voltage (vᵢₙ) is greater than a predetermined threshold voltage corresponding to the predetermined threshold current.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light emitting diode (LED) driving device comprising:
an LED unit having an input side adapted to receive an external AC input voltage, and an output side, said LED unit outputting at said output side a driving current corresponding to the input voltage; and
a current limiting unit coupled to said output side of said LED unit, and receiving the driving current from said output side of said LED unit, said current limiting unit including a parallel connection of a bypass switch and a current limiting circuit coupled across said output side of said LED unit, said bypass switch being operable between an ON-state and OFF-state;
wherein said current limiting unit is operable so as to permit flow of the driving current through one of said bypass switch and said current limiting circuit such that said current limiting unit has a first conduction impedance when said bypass switch is in the ON-state, and a second conduction impedance larger than the first conduction impedance when said bypass switch is in the OFF-state.

2. The LED driving device as claimed in claim 1, wherein said LED unit includes four LEDs that are configured as a bridge rectifier adapted for rectifying the input voltage and for outputting at said output side the driving current that corresponds to the input voltage rectified thereby.

3. The LED driving device as claimed in claim 1, wherein said current limiting circuit includes at least one of a resistor, a diode and an LED.

4. The LED driving device as claimed in claim 1, wherein said bypass switch has a control end for receiving a control signal such that said bypass switch is operable between the ON-state and the OFF-state in response to the control signal,
said LED driving device further comprising a control unit coupled to said control end of said bypass switch, adapted for detecting whether magnitude of the input voltage is greater than a predetermined threshold voltage, and outputting the control signal to said control end of said bypass switch based on the detecting result such that said bypass switch is in the ON-state upon detecting that the magnitude of the input voltage is not greater than the predetermined threshold voltage and that said bypass switch is in the OFF-state upon detecting that the magnitude of the input voltage is greater than the predetermined threshold voltage.

5. The LED driving device as claimed in claim 4, wherein:
said bypass switch further has first and second ends coupled across said output side of said LED unit;
said current limiting circuit includes
a series connection of a number (N) of impedance components, where N≧2, a first one of said impedance components being coupled to said first end of said bypass switch, an N^{th} one of said impedance components being coupled to said second end of said bypass switch, and
a number (N−1) of switches each coupled between a junction of a respective pair of said impedance components and said second end of said bypass switch, each of said switches having a control end for receiving a control signal such that each of said switches is operable between an ON-state and an OFF-state in response to the control signal received thereby; and
when said bypass switch is in the OFF-state, an impedance of said current limiting circuit serves as the second conduction impedance, and is adjustable through control of said switches such that the impedance of said current limiting circuit corresponds to the magnitude of the input voltage.

6. The LED driving device as claimed in claim 5, wherein:
said control unit is further coupled to said control ends of said switches of said current limiting circuit, and further outputs respectively the control signals to said control ends of said switches of said current limiting circuit based on the magnitude of the input voltage such that, when said bypass switch is in the OFF-state, an i^{th} one of said switches is in the ON-state and first to (i−1)^{th} ones of said switches are in the OFF-state, where i≦N−1; and
when said bypass switch is in the OFF-state, the impedance of said current limiting circuit is equal to a sum of impedances of first to i^{th} ones of said impedance components.

7. The LED driving device as claimed in claim 5, wherein each of said impedance components is one of a resistor, a diode and an LED.

8. The LED driving device as claimed in claim 1, wherein said bypass switch has a control end for receiving a control signal such that said bypass switch is operable between the ON-state and the OFF-state in response to the control signal,
said LED driving device further comprising:
a current detecting resistor coupled between said output side of said LED unit and said bypass switch of said current limiting unit for permitting flow of said driving current therethrough, and having a predetermined resistance; and
a control unit coupled to said control end of said bypass switch, detecting a voltage across said current detecting resistor to obtain the driving current, and outputting the control signal to said control end of said bypass switch such that the bypass switch is in the ON-state upon detecting that magnitude of the driving current is not greater than a predetermined threshold current and that said bypass switch is in the OFF-state upon detecting that the magnitude of the driving current is greater than the predetermined threshold current.

9. The LED driving device as claimed in claim 8, wherein:
said bypass switch further has first and second ends coupled across said output side of said LED unit;
said current limiting circuit includes
a series connection of a number (N) of impedance components, where N≧2, a first one of said impedance components being coupled to said first end of said bypass switch, an N^{th} one of said impedance components being coupled to said second end of said bypass switch, and
a number (N−1) of switches each coupled between a junction of a respective pair of said impedance components and said second end of said bypass switch, each of said switches having a control end for receiving a control signal such that each of said switches is operable between an ON-state and an OFF-state in response to the control signal received thereby; and
when said bypass switch is in the OFF-state, an impedance of said current limiting circuit serves as the second conduction impedance, and is adjustable through control of said switches such that the impedance of said current limiting circuit is proportional to the magnitude of the driving current.

10. The LED driving device as claimed in claim 9, wherein said control unit is further coupled to said control ends of said switches of said current limiting circuit, and further outputs respectively the control signals to said control ends of said switches of said current limiting circuit based on the magnitude of the driving current when said bypass switch is in the OFF-state such that an i^{th} one of said switches is in the ON-state and first to (i−1)^{th} ones of said switches are in the OFF-state, where i≦N−1, the impedance of said current limiting circuit being equal to a sum of impedances of first to i^{th} ones of said impedance components.

11. The LED driving device as claimed in claim 9, wherein each of said impedance components is one of a resistor, a diode and an LED.

12. The LED driving device as claimed in claim 1, wherein said bypass switch has a control end for receiving a control signal such that said bypass switch is operable between the ON-state and the OFF-state in response to the control signal,
said LED driving device further comprising:
a current detecting resistor coupled between said output side of said LED unit and said bypass switch of said current limiting unit for permitting flow of said driving current therethrough, and having a predetermined resistance; and
a control unit coupled to said control end of said bypass switch, detecting a voltage across said current detecting resistor to obtain the driving current, adapted to detect the input voltage so as to obtain an input power based on the driving current and the input voltage, and outputting the control signal to said control end of said bypass switch such that the bypass switch is in the ON-state upon detecting that the input power is not greater than a predetermined threshold power and that said bypass switch is in the OFF-state upon detecting that the input power is greater than the predetermined threshold power.

13. The LED driving device as claimed in claim 12, wherein:
said bypass switch further has first and second ends coupled across said output side of said LED unit;
said current limiting circuit includes
a series connection of a number (N) of impedance components, where N≧2, a first one of said impedance components being coupled to said first end of said bypass switch, an N^{th} one of said impedance components being coupled to said second end of said bypass switch, and
a number (N−1) of switches each coupled between a junction of a respective pair of said impedance components and said second end of said bypass switch, each of said switches having a control end for receiving a control signal such that each of said switches is operable between an ON-state and an OFF-state in response to the control signal received thereby; and
when said bypass switch is in the OFF-state, an impedance of said current limiting circuit serves as the second conduction impedance, and is adjustable through control of said switches such that the impedance of said current limiting circuit is proportional to the input power.

14. The LED driving device as claimed in claim 13, wherein said control unit is further coupled to said control ends of said switches of said current limiting circuit, and further outputs respectively the control signals to said control ends of said switches of said current limiting circuit based on the input power when said bypass switch is in the OFF-state such that an i^{th} one of said switches is in the ON-state and first to (i−1)^{th} ones of said switches are in the OFF-state, where i≧N−1, the impedance of said current limiting circuit being equal to a sum of impedances of first to i^{th} ones of said impedance components.

15. The LED driving device as claimed in claim 13, wherein each of said impedance components is one of a resistor, a diode and an LED.

16. The LED driving device as claimed in claim 1, wherein:
said bypass switch is a transistor that has a first end, a second end and a control end, said control end and one of said first and second ends being coupled across said output side of said LED unit;
said current limiting unit further includes an impedance component coupled between said control end and the other one of said first and second ends; and
said bypass switch is operable between the ON-state and the OFF-state in response to a voltage across said impedance component.

17. The LED driving device as claimed in claim 16, wherein said impedance component includes one of a diode, an LED and a resistor.

18. The LED driving device as claimed in claim 16, wherein said current limiting circuit includes:
a series connection of a number (N) of impedance components, where N≧2, a first one of said impedance components being coupled to the other one of said first and second ends of said bypass switch, an N^{th} one of said impedance components being coupled to said one of said first and second ends of said bypass switch; and
a number (N−1) of switches, each of which is a transistor, is coupled between a junction of a respective pair of said impedance components and said one of said first and second ends of said bypass switch, and has a control end, said control end of a first one of said switches being coupled to the other one of said first and second ends of said bypass switch, said control end of an i^{th} one of said switches being coupled to a junction of (i−1)^{th} and i^{th} ones of said impedance components, where 3≦i≦N−1, a j^{th} one of said switches being operable between an ON-state and an OFF-state in response to a voltage across a j^{th} one of said impedance components, where 1≦j≦N−1.

19. The LED driving device as claimed in claim 18, wherein each of said impedance components is one of a resistor, a diode and an LED.

20. The LED driving device as claimed in claim 1, the input voltage being a three-phase AC voltage that includes a first phase voltage, a second phase voltage and a third phase voltage, wherein said LED unit is adapted for rectifying the input voltage, outputs at said output side the driving current that corresponds to the input voltage rectified thereby, and includes three series-connected units connected in parallel, each of the series-connected units including first and second LEDs, a common node between an anode of said first LED and a cathode of said second LED of each of the series-connected units being adapted to receive a respective one of the first, second and third phase voltages, a first common node among cathodes of said first LEDs of the series-connected units, and a second common node among anodes of said second LEDs of the series-connected units constituting said output side of said LED unit;
said LED driving device further comprising a control unit for detecting a voltage across said output side of said LED unit and for outputting a control signal to said bypass switch based on the voltage detected thereby such that said bypass switch is operable between the ON-state and the OFF-state in response to the control signal.

21. The LED driving device as claimed in claim 1, wherein said LED unit includes first and second series-connected units connected in parallel, each of the first and second series-connected units including a plurality of LEDs, said LEDs of the first series-connected unit conducting when the input voltage is positive, said LEDs of the second series-connected unit conducting when the input voltage is negative.

22. The LED driving device as claimed in claim 1, wherein:
said current limiting circuit includes first and second series-connected units connected in parallel across said bypass switch, each of the first and second series-connected units including a plurality of LEDs; and
when said bypass switch is in the OFF-state, said LEDs of the first series-connected unit conduct while the input voltage is positive, and said LEDs of the second series-connected unit conduct while the input voltage is negative.

23. The LED driving device as claimed in claim 1, wherein said LED unit includes a plurality of parallel-connected units connected in series, each of the parallel-connected unit includes first and second LEDs, an anode of one of said first and second LEDs of each of the parallel-connected units being coupled to a cathode of the other one of said first and second LEDs of a corresponding one of the parallel-connected units.

24. A light emitting diode (LED) driving device comprising:
a LED unit having an input side adapted to receive an external AC input voltage, and an output side, said LED unit outputting at said output side a driving current corresponding to the input voltage; and
an variable impedance unit coupled across said output side of said LED unit, permitting flow of the driving current therethrough, and having a conduction impedance that is variable based on an adjusting signal.

25. The LED driving device as claimed in claim 24, further comprising a control unit adapted for detecting magnitude of the input voltage, and generating the adjusting signal based on the magnitude of the input voltage detected thereby.

26. The LED driving device as claimed in claim 24, further comprising:
a current detecting resistor coupled between said output side of said LED unit and said variable impedance unit, and having a predetermined resistance; and
a control unit detecting a voltage across said current detecting resistor to obtain the driving current, and generating the adjusting signal based on the driving current.

27. LED driving device as claimed in claim 24, further comprising:
a current detecting resistor coupled between said output side of said LED unit and said variable impedance unit, and having a predetermined resistance; and
a control unit detecting a voltage across said current detecting resistor to obtain the driving current, adapted to detect the input voltage so as to obtain an input power based the driving current and the input voltage, and generating the adjusting signal based on the input power.

28. The LED driving device as claimed in claim 24, wherein said variable impedance unit includes one of a MOSFET, a BJT and a variable resistor.

29. The LED driving device as claimed in claim 24, wherein said variable impedance unit has a first end and a control end coupled across said output side of said LED unit, and a second end, said control end of said variable impedance unit receiving the adjusting signal,
said LED driving device further comprising an impedance component coupled between said second end and said control end of said variable impedance unit, the adjusting signal varying with magnitude of the input voltage and corresponding to a voltage across said impedance component.

30. The LED driving device as claimed in claim 24, further comprising a current limiting circuit coupled between said output side of said LED unit and said variable impedance unit, said current limiting circuit including a plurality of series-connected units connected in parallel, each of the series-connected units including a plurality of impedance components.

31. LED driving device as claimed in claim 24, further comprising a current limiting circuit coupled between said output side of said LED unit, said current limiting circuit including at least one first series-connected unit and at least one second series-connected unit connected in parallel, said first series-connected unit including a plurality of impedance component units each including a plurality of impedance components connected in parallel, said second series-connected unit including a plurality of impedance components.

32. LED driving device as claimed in claim 31, wherein each of said impedance components includes one of an LED, a diode and a resistor.

33. The LED driving unit as claimed in claim 24, wherein said LED unit includes four LEDs that are configured as a bridge rectifier adapted for rectifying the input voltage and for outputting at said output side the driving current that corresponds to the input voltage rectified thereby.

34. LED driving device as claimed in claim 24, wherein said LED unit includes four current limiting circuits that are configured as a bridge rectifier adapted for rectifying the input voltage and for outputting at said output side the driving current that corresponds to the input voltage rectified thereby, each of said current limiting circuits including at least one first series-connected unit and at least one second series-connected unit connected in parallel, said first series-connected unit including a plurality of LED sets each including a plurality of LEDs connected in parallel, said second series-connected unit of each of said current limiting circuits including a plurality of LEDs.

35. LED driving device as claimed in claim 24, wherein said LED unit includes first and second series-connected units connected in parallel, each of the first and second series-connected units including at least one LED, said LED of the first series-connected unit conducting when the input voltage is positive, said LEDs of the second series-connected unit conducting when the input voltage is negative.

36. The LED driving device as claimed in claim 24, wherein said LED unit includes a plurality of parallel-connected units connected in series, each of the parallel-connected units including first and second LEDs, an anode of one of said first and second LEDs of each of the parallel-connected units being coupled to a cathode of the other one of said first and second LEDs of a corresponding one of the parallel-connected units.

37. A light emitting diode (LED) driving device comprising:
a bridge rectifier having an input side adapted to receive an external AC input voltage from an AC power source, and an output side;
an LED unit coupled across said output side of said bridge rectifier; and
a current limiting unit adapted to be coupled between the AC power source and said input side of said bridge rectifier, and including two NMOSFETs coupled inversely in parallel, said current limiting unit being operable so as to permit flow of a driving current that is not greater than a predetermined threshold current through said bridge rectifier to said LED unit.
